(19) United States
(12) Patent Application Publication
(10) Pub. No.: US 2025/0086583 A1
(43) Pub. Date: Mar. 13, 2025

(54) Inventory Coordination Functionality for Harmonizing Procurement Across Distribution Networks

(71) Applicant: Direct Supply, Inc., Milwaukee, WI (US)

(72) Inventors: Paul J. Clarke, Sussex, WI (US); Brittany A. Zimmer, Libertyville, IL (US); Lucas W.G. Wilson, Milwaukee, WI (US)

(21) Appl. No.: 18/828,581

(22) Filed: Sep. 9, 2024

Related U.S. Application Data
(60) Provisional application No. 63/537,311, filed on Sep. 8, 2023.

(51) Int. Cl. G06Q 10/087

(52) U.S. Cl. CPC G06Q 10/087

(57) ABSTRACT

Systems, methods, and media that can be used to provide inventory coordination functionality for harmonizing procurement across distribution networks. Responsive to initiating a change to an order guide that is used to order products for a facility, a demand signal can be generated that is indicative of a change in demand for a product that is provided by a distributor. Then, the demand signal can be provided to the distributor to facilitate a change in inventory for the product. Responsive to determining that the change in demand for the product is complete, the requested order guide change can be implemented, and the order guide can be used to place an order for the product for the facility.

### CROSS-REFERENCE TO RELATED APPLICATION

This application is based on and claims priority to U.S. Provisional Patent Application No. 63/537,311, filed on Sep. 8, 2023, the entire disclosure of which is incorporated herein by reference.

### BACKGROUND

Many organizations frequently purchase or repurchase the same products, such as food, linens, janitorial supplies, medical supplies, maintenance, repair, and operating items (MRO), and the like. In an effort to manage brand requirements (e.g., a breakfast menu for a hotel associated with a particular brand), regulatory requirements (e.g., specific medical supplies required to perform a treatment, dietary requirements for school meal programs), control costs, manage the delivery process, and assure the consistency of supply and quality of such products, an organization may establish a relationship with one or more distributors for such products. For example, a distributor can purchase products from one or more suppliers (e.g., manufacturers, wholesalers, other distributors, farms, and the like) on favorable terms due to the large number of products that the distributor has contracted to purchase on a regular basis. In turn, the distributor may offer relatively favorable terms to institutional customers that contract to repeatedly purchase the same or similar products. As such a customer can be a source of stable revenue. An alternative to such an arrangement is for the organization to attempt to purchase products directly from suppliers, but this can raise the organization's transaction costs, and the organization would be unlikely to have the leverage to negotiate the same terms as the distributor due to the much smaller volumes the organization purchases. Another alternative is for the organization to purchase products from other intermediaries, such as wholesalers, or retailers. However, such intermediaries often offer too limited of a range of products (e.g., in the case of wholesalers) and/or charge relatively higher prices than a distributor (e.g., in the case of retailers). While such alternative arrangements may be workable for some organizations, such as organizations with a small number of ordering locations or a limited geographic scope, such alternative arrangements may not be workable for more complex organizations with large numbers of ordering locations and/or a large geographic scope. For example, such a complex organization may find the transaction costs associated with achieving the consistency in purchasing products to meet the brand requirements, operating requirements, supply requirements, regulatory requirements, and/or quality requirements under which the organization operates to be prohibitively high.

While a distributor can act as a single point of sale for a broad range of products and potentially distribute products from multiple locations, the products offered by the distributor can vary widely from place to place, or time to time. This can be especially true for perishable goods such as produce, dairy, baked goods, and the like, where suppliers often have a logistics-limited ability to provide a product while also meeting quality, cost, and/or temporal objectives simultaneously. This can make it more difficult for an organization with multiple facilities spread over a relatively wide area to order from the distributor, or even a single facility can struggle when product offering fluctuate or become unpredictably unavailable. For example, while the organization may require the same items in each order, the distributor may not have the same item available in each region servicing those facilities. Accordingly, the organization cannot simply place a single order and always know that it will receive the exact product or request that an order covering multiple facilities be fulfilled for each facility due to such regional and/or temporal variations. Additionally, an organization would often need to identify valid substitutes that meet the item requirements and specifications for every item that cannot be purchased and delivered consistently across their entire organization. This can increase the administrative burden of an organization interacting with the distributor. For example, rather than a single part of the organization being responsible for interacting with the distributor, organizations may let each facility take on responsibility for ordering supplies for itself subject to standards set by the parent organization. Aside from the inefficiency of having multiple parts of the organization performing the same task, this can also have other undesirable consequences. In the case of a single facility, employees may be required to monitor and reconcile orders or anticipated orders based on product availability, which can require, in some cases, hours of analysis and reconciliation daily. For example, the organization's ability to enforce purchase contracts and rebates may be significantly impaired by a lack of systems and procedures to enforce purchase commitments and collect data to submit for contract purchase rebates. Moreover, with respect to product substitutions that occur during the ordering process (e.g., due to certain products being out of stock, etc.), the distributor typically is not aware of the organization's standards with respect to product ordering. However, the distributor may still be expected (e.g., by general business agreement with the organization) to provide substitute products under certain circumstances. If the distributor does not have sufficient information regarding the standards of the organization, the substitutes chosen by the distributor can be undesirable when compared to a substitute that would be chosen by the organization (or facility) with the proper insight, thereby creating various inefficiencies in the procurement process. Similarly, when different order guide changes are made by an organization, the organization may not be aware of inventory levels maintained by one or more distributors for products that are added to the order guide. Additionally, the distributors may not have visibility into the changing demand levels for different products based on order guide changes as necessary to efficiently distribute products.

As one example, the organization may be a member of a group purchasing organization (GPO), which can represent a group of similar organizations (e.g., hospitals, hotels, schools, and the like) to provide increased negotiating leverage. Such a GPO can negotiate with distributors and/or suppliers for lower prices, discounts, rebates, and the like, for its members. While the organization itself is likely aware of this relationship with the GPO, each facility may not be, and therefore may not take advantage of the prices, discounts, and/or rebates negotiated by the GPO. This can result in some facilities having unnecessarily high costs. Similarly, the organization can directly negotiate with a distributor and/or supplier for a price reduction or discount on a particular product, but individual facilities may not be aware of such negotiations. For example, the organization can establish an order guide with a distributor that includes a number of preferred items, which can in some cases be ordered at reduced prices. However, individuals placing the orders for items may not be aware of the order guide. As another example, the organization can interact with a supplier (e.g., a producer of condiments) to negotiate a rebate when a sufficient quantity of that supplier's product is purchased. In such an example, the organization may intend to exclusively order products produced by that supplier, but individuals actually responsible for ordering items for each facility may not be aware of the organization's intentions. Even if the individual is aware of the intent, the individual may not recognize why the organization is requesting that they order that supplier's products, especially if the individual ordinarily orders the same type of item that is produced by a different supplier. The sorts of difficulties described above can make it difficult or impossible for an organization to enforce its business model objectives on purchase contract compliance, which can lead to the organization failing to achieve the cost and operating efficiencies it desires.

These situations represent only a handful of the challenges that purchasers, facilities management, and other individuals involved in procurement confront regularly. Across a broad spectrum of industry segments, from food service, to healthcare, to hospitality, to education, to entertainment, the challenges within each industry share many of the above-described general complexities and challenges, and then layer on additional complexities that are specific to the industry. For example, in healthcare food service, it may be necessary to manage nutritional requirements in addition to general product type, availability, and cost. Thus, when layering all of these requirements, from the financial, to the geographical, to the nutritional, to patient care, the process of purchasing, reconciling, and substituting purchases can become extremely cumbersome, if not impossible when time and cost constraints are considered. Additional background material pertaining to this disclosure can be found in U.S. Pat. No. 10,685,308, the entire disclosure of which is incorporated herein by reference.

Accordingly, new systems, methods, and media for harmonizing procurement across distribution networks with heterogeneous product availability are desirable.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of distribution networks connecting various suppliers and end users in which costs and product choice can be negotiated between any pair or more of parties associated with the distribution networks.

FIG. 2 shows an example of paths along a distribution network from two suppliers to a single end user associated with multiple facilities in different geographic regions and the potential for a lack of availability across regions that can cause inconsistency in products that are delivered to the various facilities.

FIG. 3A shows an example of a portion of a distribution network connecting various suppliers to a single end user associated with multiple facilities in different geographic regions via a single distributor associated with a system for harmonizing procurement across distribution networks with heterogeneous product availability implemented in accordance with some embodiments of the disclosed subject matter.

FIG. 3B shows an example of a portion of a distribution network connecting various suppliers to multiple facilities in different geographic regions via a single distributor associated with a system for harmonizing procurement across distribution networks with heterogeneous product availability implemented in accordance with some embodiments of the disclosed subject matter.

FIG. 4 shows an example of a system for harmonizing procurement across distribution networks with heterogeneous product availability in accordance with some embodiments of the disclosed subject matter.

FIG. 5 shows an example of hardware that can be used to implement server and computing device in accordance with some embodiments of the disclosed subject matter.

FIG. 6 shows an example of a process for creating and using an order guide to procure items for one or more facilities in accordance with some embodiments of the disclosed subject matter.

FIG. 7 shows an example system for optimizing ordering events within a procurement system in accordance with some embodiments of the disclosed subject matter.

FIG. 8 shows an example process for generating substitute product recommendations in accordance with some embodiments of the disclosed subject matter.

FIG. 9 shows an example process for presenting and applying substitute product recommendations within a shopping cart user interface in accordance with some embodiments of the disclosed subject matter.

FIG. 10 shows an example shopping cart user interface that can efficiently facilitate product substitutions during procurement in accordance with some embodiments of the disclosed subject matter.

FIG. 11 shows an example user interface including search results for a first type of product in accordance with some embodiments of the disclosed subject matter.

FIG. 12 shows an example user interface including search results for a second type of product in accordance with some embodiments of the disclosed subject matter.

FIG. 13 shows another example shopping cart user interface that can efficiently facilitate product substitutions during procurement in accordance with some embodiments of the disclosed subject matter.

FIG. 14 shows another example shopping cart user interface that can efficiently facilitate product substitutions during procurement in accordance with some embodiments of the disclosed subject matter.

FIG. 15 shows another example shopping cart user interface that can efficiently facilitate product substitutions during procurement in accordance with some embodiments of the disclosed subject matter.

FIG. 16 shows another example shopping cart user interface that can efficiently facilitate product substitutions during procurement in accordance with some embodiments of the disclosed subject matter.

FIG. 17 shows another example shopping cart user interface that can efficiently facilitate product substitutions during procurement in accordance with some embodiments of the disclosed subject matter.

FIG. 18 shows an example shopping list user interface that can efficiently facilitate product substitutions during procurement in accordance with some embodiments of the disclosed subject matter.

FIG. 19 shows another example shopping list user interface that can efficiently facilitate product substitutions during procurement in accordance with some embodiments of the disclosed subject matter.

FIG. 20 shows another example shopping list user interface that can efficiently facilitate product substitutions during procurement in accordance with some embodiments of the disclosed subject matter.

FIG. 21 shows another example shopping list user interface that can efficiently facilitate product substitutions during procurement in accordance with some embodiments of the disclosed subject matter.

FIG. 22 shows another example shopping list user interface that can efficiently facilitate product substitutions during procurement in accordance with some embodiments of the disclosed subject matter.

FIG. 23 shows another example shopping list user interface that can efficiently facilitate product substitutions during procurement in accordance with some embodiments of the disclosed subject matter.

FIG. 24 shows an example user interface including product search results and associated substitute recommendations in accordance with some embodiments of the disclosed subject matter.

FIG. 25 shows an example process for optimizing ordering events within a procurement system in accordance with some embodiments of the disclosed subject matter.

FIG. 26 shows an example system for coordinating product inventory with order guide changes in accordance with some embodiments of the disclosed subject matter

FIG. 27 shows a graphical illustration of an example order guide product inventory change process that can be implemented using the system of FIG. 26 in accordance with some embodiments of the disclosed subject matter.

FIG. 28 shows an example order guide management user interface that can be used to request a change to an order guide in accordance with some embodiments of the disclosed subject matter.

FIG. 29 shows another example order guide management user interface that can be used to manage order guide changes in accordance with some embodiments of the disclosed subject matter.

FIG. 30 shows an example process for coordinating product inventory with order guide changes in accordance with some embodiments of the disclosed subject matter.

FIG. 31 shows another example process for coordinating product inventory with order guide changes in accordance with some embodiments of the disclosed subject matter.

### DETAILED DESCRIPTION

In accordance with various embodiments, mechanisms (which can, for example, include systems, methods, and media) for inventory coordination functionality for harmonizing procurement across distribution networks with heterogeneous product availability are provided.

In accordance with some embodiments, the mechanisms described herein can collect information about which products are available from a distributor across a distribution network, which may include geographical regions. For example, each distributor may utilize different data applications and/or data structures (e.g., database) to track information (e.g., products currently stocked) for different portions of the supplier and/or distributor's business. For example, different corporations, divisions, subsidiaries, and the like, associated with a particular supplier and/or distributor can be associated with different data applications and/or data structures. As another example, different distribution centers associated with a particular supplier and/or distributor can be associated with different data applications and/or data structures. As yet another example, different regions in which a supplier and/or distributor operates can be associated with different data applications and/or data structures. Each of the different data applications and/or data structures in the preceding examples may be represented in different ways and may include multiple databases configured by corporation, region, distribution center or some other database structure. In some embodiments, the mechanisms described herein can collect information associated with products stocked or otherwise available via different portions (e.g., nodes, distribution centers, warehouses) of a distribution network. The mechanisms described herein can accept a wide range of information from the organization and manage orders across different portions of a distribution network, availability, geography, time constraints, cost preferences, contractual relationships, and the like to automatically manage orders, even without or with minimized manual interaction.

In some embodiments, the mechanisms described herein can interact with an organization (e.g., via a user) to gather information about the organization's facilities and/or contractual relationships with group purchasing organizations, suppliers, and/or one or more distributors. For example, the user can provide the mechanisms described herein with information about each facility that is to be supplied via a particular distributor, such as the facility's location. Note that the term facility as used herein is intended to be non-limiting. For example, while a facility can refer to a structure or a place, such as a single building, it can also refer to a portion of a building, a group of multiple buildings that may or may not be located near each other, a campus, a vehicle (e.g., a “food truck”, a mobile home, or the like). Additionally, facility as used herein can refer to non-places, such as a juristic entity (e.g., a corporation, a foundation, a government agency, or the like), or a natural person. Specific examples of a facility can include a healthcare facility (e.g., a hospital, an outpatient clinic, a standalone emergency facility, a standalone hospice facility, a hospital campus, a specific building on a hospital campus, a hospital cafeteria, or the like), an elder care facility (e.g., an assisted living facility, an independent living facility, a nursing home, or the like), an educational facility (e.g., a school, a university campus, a building on a university campus, a cafeteria on a university campus which may be located within a different facility such as a dorm, or the like), a corporation, a corporate campus, a government agency, a government building, a group of government buildings, a restaurant, a chain of restaurants, a particular vehicle (e.g., cart, truck) used to deliver and/or vend a product (e.g., prepared food), a home, a portion of a home (e.g., a home office). Another example of a facility can be anything that has an address or that is located at a particular place or places. Yet another example of a facility can be anything that is affiliated with an organization, and that independently orders products via the affiliation with the organization.

In some embodiments, the mechanisms described herein can provide a user interface that a user can access to view a full list of products available from a distributor across the distribution network (e.g., such as the regions in which the organization has a facility). For example, the organization may be a provider of elder care services with elder care facilities in various locations. If the organization is a customer of a particular food distributor with distribution nodes in various regions, the organization may have facilities in more than one of these regions. In such an example, the mechanisms described herein can collect information about food items available from the food distributor across the various super-regional, regional, and/or local distribution subnetworks, and provide a user interface that allows a user associated with the organization to view the products available across at least all of the regions in which a facility associated with the organization is located.

In some embodiments, the mechanisms described herein can receive one or more selections of items to include in an order guide associated with the organization (sometimes referred to herein as a general order guide), and an indication of one or more facilities to associate with the order guide. In some embodiments, a user can cause the mechanisms described herein to automatically create one or more order guides that can be used to place one or more orders based on the general order guide(s) associated with each facility. For example, if a first facility and a second facility are associated with a first general order guide that includes a list of items, the mechanisms described herein can generate a facility-specific order guide for the first facility based on the first general order guide, and a facility-specific order guide for the second facility that is also based on the first general order guide. Note that order guide as used herein is intended to be non-limiting. For example, an order guide can refer to a collection of products, product groups, master items, items, services, deliverables, and/or any other thing(s) that may be the subject of procurement activities. In such an example, the order guide can be used (e.g., by an organization, facility, distributor, supplier, individual, and/or a user associated therewith) to facilitate procurement activities. As another example, a catalog that includes various products and/or services that can be ordered can be considered an order guide.

In some embodiments, the mechanisms described herein can receive one or more selections of items to include in a list of acceptable alternatives. For example, a user can select an equivalent item from multiple different brands as being acceptable alternatives. In some embodiments, such a list can be associated with one or more order guides such that, when the mechanisms described herein create a facility-specific order guide for a particular facility, the mechanisms can automatically select an alternative for an item that is not available in a particular region (e.g., because the item is discontinued, because the item is out of stock, because the item is superseded, because the item is not available in that region, and the like).

In some embodiments, the mechanisms described herein can automatically suggest acceptable alternatives when an item selected by a user is not available across all nodes of the distribution network(s) utilized by the user. For example, if a user selects a first item for inclusion in an order guide, the mechanisms described herein can determine that the first item is not available in at least one portion of the distribution network that is preferable for one or more facilities in the organization. In such an example, the mechanisms described herein can present one or more similar items that are available via a node through which the first item is not available as a potential alternative. In some embodiments, the mechanisms described herein can periodically identify similar items, such that the items can be presented as potential alternatives.

In some embodiments, the mechanisms described herein can automatically suggest opportunities for significant savings based on information about an organization and information about the items selected and/or ordered by the organization. For example, in some embodiments, the mechanisms described herein can identify a less-costly potential alternative to an item that an organization is planning on ordering and can calculate an estimated annual savings by switching the order to the alternative.

In some embodiments, the mechanisms described herein can provide a system and/or service that can be used by an organization to track inventory associated with various facilities and/or provide a user interface for ordering items that are needed at a particular facility. For example, mechanisms described herein can provide a system and/or service that can be used by an organization to track where items are stored in a particular facility. As another example, mechanisms described herein can provide a system and/or service that can be used by an organization to track when various items (especially perishable items) were received. As yet another example, mechanisms described herein can provide a system and/or service that can be used by an organization to suggest which items to use next (e.g., based on when the item was received, a sell-by date associated with the item, a shelf life associated with the item, or the like). In some embodiments, the mechanisms described herein can provide a system and/or service that can be used by an organization to designate an item that is running low as an item that needs to be ordered. In some embodiments, the mechanisms described herein can provide a system and/or service that can be used by an organization to identify items under voluntary recall and/or under recall by a regulatory body, such as the Federal Food and Drug Administration (FDA), and identify items that should not or cannot be used. For example, the mechanisms described herein can identify when a regulator body (e.g., the FDA) and/or one or more organizations regulated by such a body (e.g., food producers) recalls products from the marketplace, such as in response to the product under recall being mislabeled, when a food product may present a health hazard to consumers because the food is contaminated or has caused a foodborne illness outbreak.

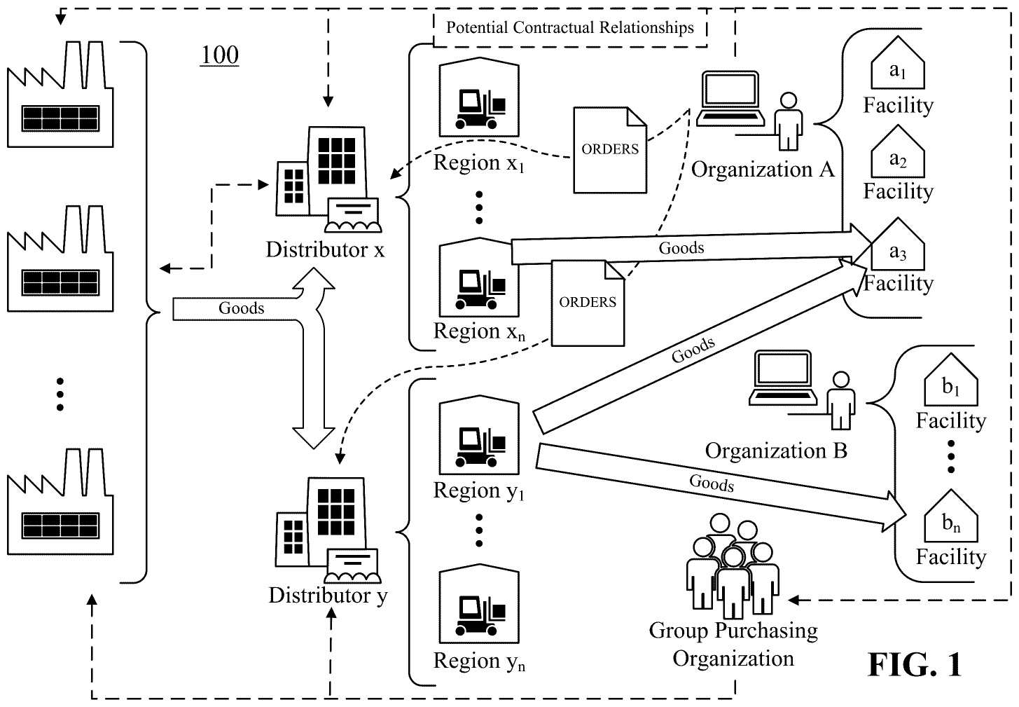

FIG. 1 shows an example 100 of distribution networks connecting various suppliers and end users in which costs and product choice can be negotiated between any pair or more of parties associated with the distribution networks. As shown in FIG. 1, many parties can be involved in distributing goods (e.g., food, medical supplies, janitorial supplies, household goods, and the like) from suppliers to organizations that use the goods. For example, one or more distributors can purchase goods from various suppliers with the intent of distributing the goods through regional distribution centers (e.g., warehouses or networks of warehouses in various geographical locations). In such an example, a distributor can negotiate with each supplier regarding the price that the distributor will pay to the supplier, how much of a particular item the distributor will order, how the goods will be transported from the supplier to the distributor, and/or any other terms related to the procurement by the distributor of products from the supplier. Due to the relatively large volumes that distributors are often willing to order from a supplier, the distributor may be able to secure a discounted price compared to what an end user would pay to a retailer offering the same product(s).

In many cases, some goods may be available from a particular supplier in one sales channel or region, but not in another. For example, suppliers of perishable food may only offer certain foods in a geographically limited territory due to the relatively short shelf life of the product. In such an example, a distributor may have to establish relationships with different suppliers for the same items in different places, which may overlap (e.g., item one may be offered by supplier one in a first region, and an equivalent of item one may be offered by supplier two in a second region that overlaps the first region in certain areas). These regions may also overlap with the regions in which the distributor has established distribution centers. Accordingly, to ensure that customers of the distributor can order at least one item or its equivalent from another supplier, the distributor may purchase the items from both suppliers, and stock them where they are available. In such an example, some distribution centers may stock the first item, other distribution centers may stock the second item, and yet other distribution centers may stock the first item and the second item. As another example, a distributor that operates in multiple countries may be unable to stock a particular item from a first supplier in each country in which it operates (e.g., due to transportation costs, regulations, and the like), and accordingly may purchase equivalent items from multiple suppliers in various countries or regions.

A distributor establishes networks of distribution centers in order to provide products purchased from suppliers to the distributor's customers. In many cases, the customer may be an organization that operates across more than one of the regions served by the distributor. For example, a health care provider may operate a network of facilities in many different geographic regions. In a more particular example, the health care provider may establish elder care facilities in various metropolitan areas across several states.

Such organizations can establish relationships with a distributor to, among other things, reduce costs. For example, an organization can establish a relationship with a food distributor to supply ingredients and/or ready to cat food to all of the organization's facilities. By ordering relatively large quantities, the organization can receive a relatively low price. Additionally, the distributor can provide logistical support in coordinating delivery of food to the various different facilities. However, the organization still needs to interface with the distributor to order the food that is needed by each facility, which can be a significant administrative task that can be complicated due to different facilities having different needs or being located in different regions such that the same items cannot be supplied by the distributor to all of the facilities.

As shown in FIG. 1, an organization can have a relationship with a group purchasing organization (GPO) that can negotiate with multiple other parties, such as distributors and/or suppliers on behalf of the member organizations of the GPO. For example, a GPO can negotiate with a supplier for a coupon or rebate that member organizations can use to lower the cost of purchasing that supplier's products. As another example, a GPO can negotiate with a distributor for a discount that that member organizations can use to lower the cost of purchasing items through that distributor.

In some cases, a GPO can be responsible for tracking volumes ordered by members (e.g., organizations) of the GPO, and distribute rebates, earnings, and/or dividends based on the ordering volumes. For example, a GPO can receive funds from distributors and/or suppliers (e.g., in the form of fees, or rebates) on behalf of members, and can distribute the funds based on orders placed by the member organizations. Additionally, in some cases, GPOs that are classified as purchasing cooperatives can distribute funds as dividends to member organizations. For example, to accurately calculate rebates and funds distributions the GPO often must use reporting and discovery mechanisms (e.g., processes and/or systems) to determine items and quantities ordered by each organization, and when the items were ordered. Additionally, a GPO can use multiple mechanisms to obtain information about the purchasing behaviors of its member organizations to identify contracting and cost reduction opportunities. Should the GPO have visibility to items for which the GPO has not negotiated a contract with a distributor but has sufficient qualities to be included in a contract negotiation, the GPO can negotiate a contract for that product to the potential advantage of the GPO's members that already purchase or wish to purchase that product.

Many distributors provide a platform that allows customers to track and submit orders electronically. One or more users (in some cases with the assistance of one or more automated services) associated with an organization can submit orders to a distributor for various facilities associated with the facility.

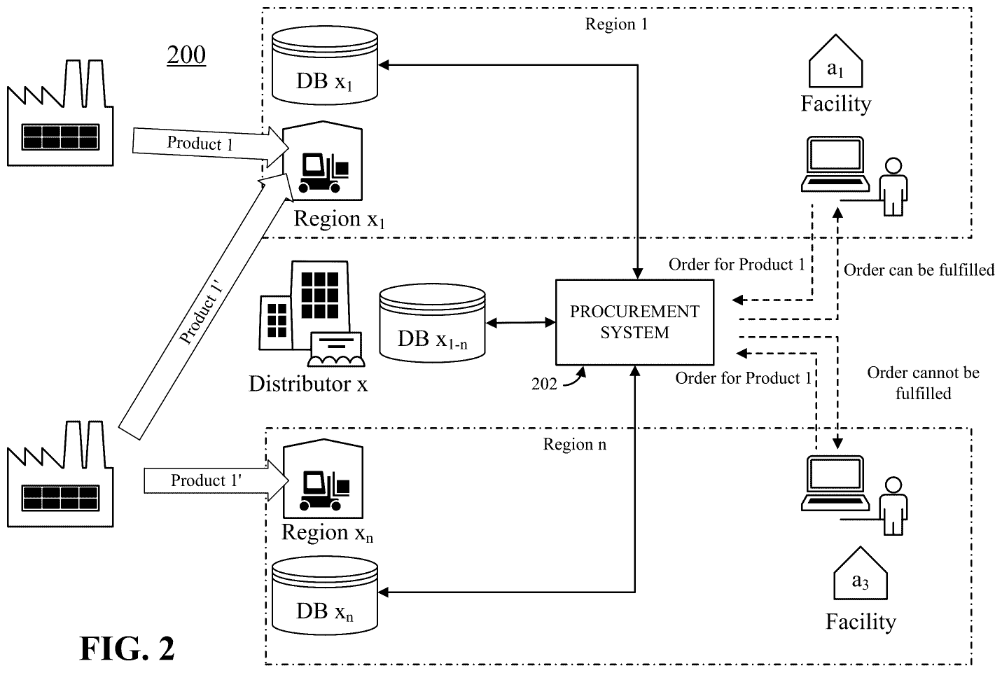

FIG. 2 shows an example 200 of paths along a distribution network from two suppliers to a single end user associated with multiple facilities in different geographic regions and the potential for a lack of availability across regions that can cause inconsistency in products that are delivered to the various facilities. As shown in FIG. 2, an organization (e.g., “Organization A” in FIG. 2) can order the same item (e.g., “Product 1”) from the same distributor for different facilities, but if those facilities are aligned with different portions of the distributors network (e.g., “Region 1” and “Region n”, respectively) the product may be available in one portion of the network, but not the other. In such an example, an alternative to the item may be available (e.g., “Product 1”) that originated from a different supplier. However, this may not be clear to the user(s) placing orders for the organization. For example, the user may be restricted to viewing items available in only one region at a time, or the region(s) in which the item(s) are available may not be clear from the user interface. In such an example, a user may create an order for one facility and attempt to use that order as a template for creating orders for other similar facilities, only to find out that one or more items ordered for the first facility are not available for delivery to the other facilities. Consequently, if the organization attempts to order the item for both facilities (e.g., because the item fits a need, because the item is discounted, or the like), the distributor may not be able to fulfill the order in the second region, or fulfillment may be delayed by routing the ordered item from the first region to the second region. In some cases, the distributor may inform the user that the ordered item is not available for delivery or delivery may be delayed to the facility in the second region, and the user may initiate ordering a different item. However, it may be difficult for the user to identify an acceptable alternative to the originally ordered item, for example if the item was selected to fulfill nutritional requirements it may not be apparent which other items similarly fulfill those nutritional requirements. In some cases, a user associated with each facility (e.g., a facility manager, a kitchen manager, a supply manager, or the like) may use a procurement system 202 to place an order with a distributor, and the procurement system 202 can interface with a system (e.g., a database) or systems maintained by the distributor. When a user places an order for a particular item for a particular facility, the procurement system 202 can interact with the distributor's system(s) to determine whether the item is available in the distribution center serving the facility. For example, the procurement system 202 can query a database that the distributor maintains that has information on currently available products in each region. As another example, the procurement system 202 can query a database that the distributor maintains that has information on currently available products in a particular region (e.g., DB x₁). As another example, the procurement system 202 can maintain a database with information on facility to distribution center connections (e.g., distribution centers each facility can receive orders from, or conversely, facilities each distribution center serves), such that the system can determine whether an item is available to a facility based on a corresponding connection to one or more distribution centers and the availability of the item at the connected distribution centers serving the facility. A database (e.g., a catalog) of products currently available for each distribution center may be maintained by the procurement system 202 or may be maintained by the distributor systems (e.g., via the distributor database server 410), or both. As yet another example, the procurement system 202 can query a database that the distributor maintains that has information on currently available products in a particular region (e.g., DB x₁). As yet another example, the procurement system 202 can use information most recently received from the distributor (e.g., in a nightly data dump) to generate an order, and upon receiving the order the distributor can determine whether each item in the order is currently available in the region that serves the facility associated with the order. In such an example, after an order is submitted it may be rejected, and the user may be required to modify the order to add a different item (e.g., by conducting a user-directed search for an alternative).

In some cases, some organizations may not encounter such a situation. For example, an organization may designate an employee at each facility (e.g., a kitchen manager at an elder care facility) to determine what is required and place orders with the distributor. In such an example, because a user at each facility is independently determining what to order and placing orders with the distributor, the user may be less likely in some scenarios to order something that is not available in that region. However, while distributing the responsibility of ordering can help avoid ordering unavailable items, it can also increase costs and produce inefficiencies. Also, even in routine ordering done by a single user at each facility, reuse of previous orders (e.g., the same order from last week) can still create potential obstacles in terms of product availability,

Note that although not shown, a supplier can also be associated with its own distribution network that facilitates delivery more directly between the supplier and end users in addition to, or in lieu of, being part of a distribution network associated with a distributor. For example, a supplier can act as both a supplier and a distributor. As another example, a distributor can act as a supplier, by manufacturing (e.g., either directly or by contracting with a manufacturer) items for distribution via its own and/or other distributor's distribution networks. In some embodiments, the mechanisms described herein can be used to generate order guides that include items available from one or more distributors, and/or directly from a supplier via a distribution network associated with the supplier.

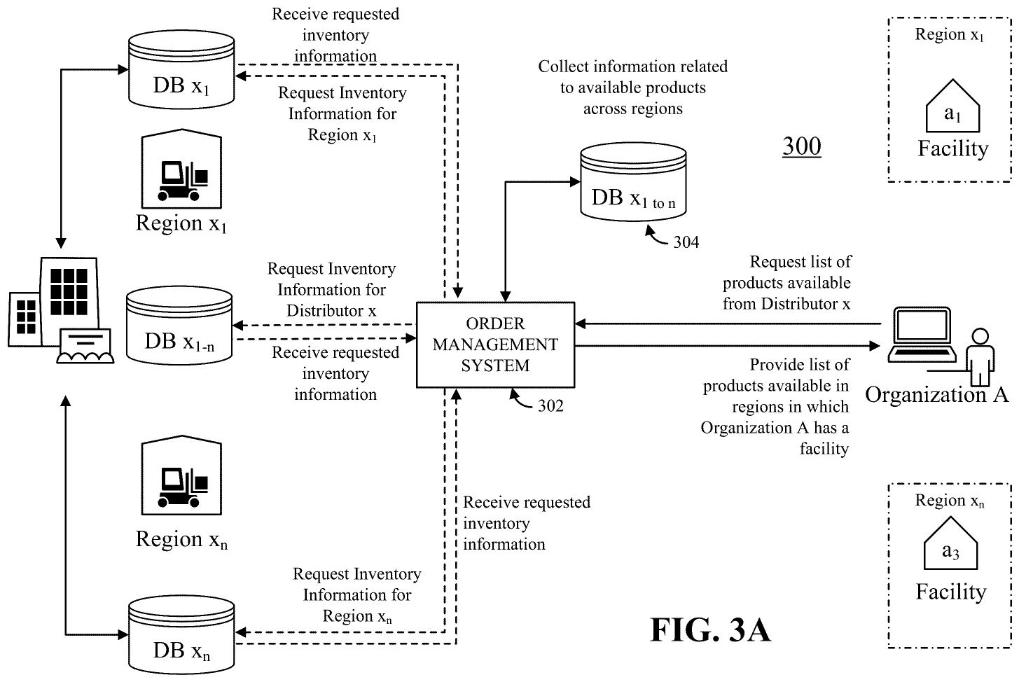

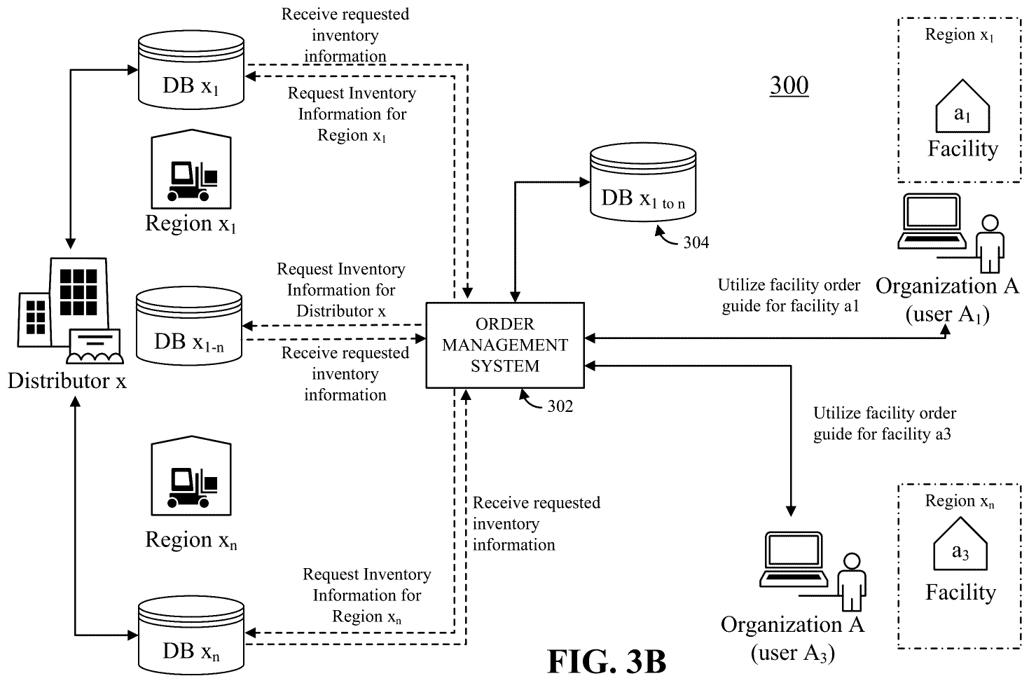

FIG. 3A shows an example 300 of a portion of a distribution network connecting various suppliers to a single end user associated with multiple facilities in different geographic regions via a single distributor associated with a system for harmonizing procurement across distribution networks with heterogeneous product availability implemented in accordance with some embodiments of the disclosed subject matter. Notably, the constraint of “geographical region” is but one non-limiting example of a constraint related to a path in a distribution network or order and many others may be substituted or layered. As shown in FIG. 3A, in some embodiments, mechanisms described herein can be used to present a user with all products that are available across regions in which an organization has a facility. As shown in FIG. 3A, in some embodiments, an order management system 302 can collect information about the products that are stocked and/or are generally available in each region in which a distributor operates. In some embodiments, order management system 302 can query the database (or databases) for information about inventory currently available in one or more regions and can collect the information into a database 304.

In some embodiments, a user (e.g., associated with organization A) can access the information in database 304 via an application and/or service that is configured to interact with database 304. For example, the user can access an application and/or service via a computing device.

In some embodiments, the user can request a list of products available from a distributor associated with database 304 by causing a computing device to send a request to order management system 302. Order management system 302 can determine, based on information about the organization, which items to present (e.g., all items available, only items available within regions in which a facility is located, and the like).

In some embodiments, order management system 302 can be configured to sort, search, filter, and the like, items available from the distributor to assist a user in identifying items that meet the organization's needs. Note that although FIG. 3A illustrates an example where information is gathered across various regions associated with a single distributor, the mechanisms described herein can also be used to provide an interface with multiple distributors, which may or may not have overlapping inventory. For example, an organization may have many facilities that are served by one distributor but may have one or more facilities that are not served by the distributor. In such an example, the organization may need to find a different distributor to source goods to such facilities. In some embodiments, the mechanisms described herein can collect information from multiple distributors to facilitate more efficient order management across all of an organization's facilities. Additionally, even when a facility is served by both distributors, there may be differences in price and/or inventory that would make it advantageous to place orders with both distributors. In some embodiments, the mechanisms described herein can automatically place orders with different distributors for a single facility based on product availability, price, and/or any other suitable factors.

FIG. 3B shows an example of a portion of a distribution network connecting various suppliers to multiple facilities in different geographic regions via a single distributor associated with a system for harmonizing procurement across distribution networks with heterogeneous product availability implemented in accordance with some embodiments of the disclosed subject matter. As shown in FIG. 3B, users associated with individual facilities (e.g., user A₁) of the organization can interact with order management system 302 to utilize a facility order guide that is based on one or more general order guides assigned to the facility, and the portion of the distribution network(s) in which the facility is located (e.g., region x₁). For example, user A₁ can download a facility order guide from order management system 302. As another example, user A₁ can request the facility order guide via another application (e.g., a procurement application), and order management system 302 can provide the requested facility order guide to a computing device associated with the application.

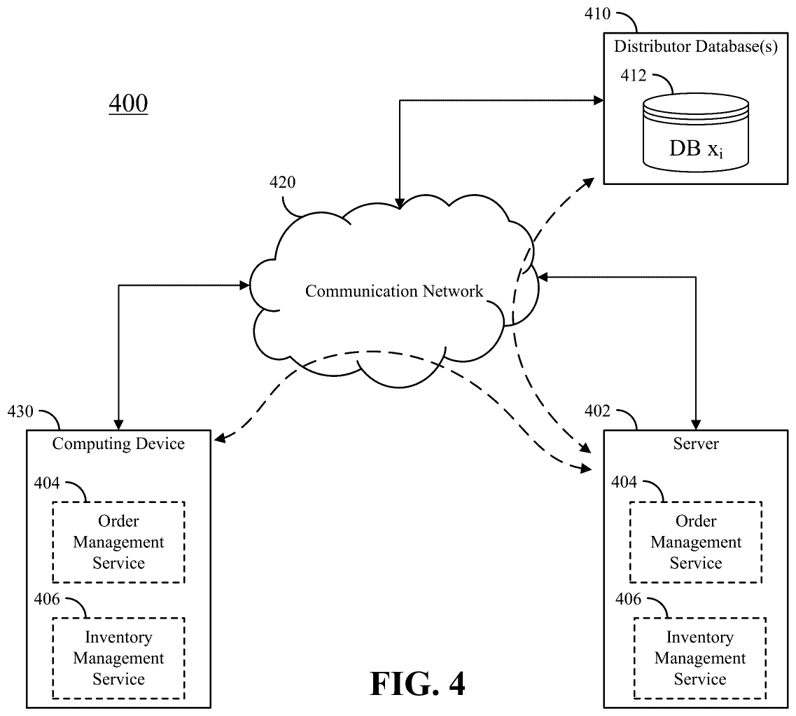

FIG. 4 shows an example 400 of a system for harmonizing procurement across distribution networks with heterogeneous product availability in accordance with some embodiments of the disclosed subject matter. As shown in FIG. 4, a server (or other processing unit) 402 can execute one or more applications to provide access to an order management service 404 and/or an inventory management service 406. In some embodiments, order management service 404 can facilitate creation of one or more order guides (e.g., general order guides associated with the organization), association of an order guide with one or more facilities, creation of one or more facility-specific order guides based on any general order guides associated with the facility, creation of master lists, and/or order placement. Note that in some embodiments, order placement functionality can be provided via one or more other services and/or applications. For example, order placement can be performed using a procurement service that is configured to receive an order guide (e.g., a general order guide, a facility-specific order guide, or the like). Additionally, in some embodiments, order management service 404 can identify similar products that may be alternatives to each other, both within a particular subnetwork of the distribution network and across different portions of the distribution network (e.g., delineated by geographical regions), and can provide suggestions of acceptable alternative items. In some embodiments, inventory management service 406 can assist an organization in the management of inventory in one or more of its facilities. For example, inventory management service 406 can be used in connection with a mobile computing device and one or more devices that emit a signal that can be used to determine a location of the mobile device. When items are stored, a user (e.g., a person delivering items, an employee of the facility, and the like) can provide an input indicating that a particular item is being stored, and inventory management service 406 can determine and record a location at which the particular item is being stored, such that when the item is needed a user can query inventory management service 406 to determine where the item can be retrieved.

In some embodiments, server 402, order management service 404, and/or inventory management service 406 can receive requests for information, queries, selections of items, user input, and/or any other suitable data, over a communication network 420. In some embodiments, such information can be received from any suitable computing device, such as computing device 430. For example, computing device 430 can receive user input through an application being executed by computing device 430, such as through an input device (e.g., a keyboard, mouse, microphone, touchscreen, and the like). In such an example, computing device 430 can communicate information over a communication network 420 to server 402 (or another server that can provide the information to server 402). As shown in FIG. 4, order management service 404 and/or inventory management service 406 can be implemented using computing device 430 and/or server 402. For example, server 402 can be used to implement at least a portion of a back-end of order management service 404 and/or inventory management service 406 and computing device 430 can be used to implement at least a portion of a front-end of order management service 404 and/or inventory management service 406.

In some embodiments, server 402 can communicate with one or more computing devices, such as distributor database server 410, to collect information regarding products that are currently available, products that are normally available, a quantity of each product that is available, pricing information about the products, and/or any other suitable information. In some embodiments, distributor database server 410 can be used (e.g., by a distributor and/or by a regional facility), to manage information about a particular distribution center or distribution centers. For example, distributor database server 410 can be used to manage a database 412 that includes information about a particular distribution center associated with a particular distributor. As shown, database 412 is associated with Distributor X and Distribution Center i (of n total distribution centers). However, this is merely an example, and distributor database server 410 can manage any suitable database or combination of databases. For example, distributor database server 410 can be used to manage a database that includes information about multiple distribution centers associated with a single distributor. In a more particular example, a particular distributor may use a single database to track products across multiple distribution centers, while a different distributor may use a different database to track products for each distribution center. As another more particular example, a single distributor may use different techniques for tracking products across different regions and/or different parts of a corporate structure. In such an example, different divisions and/or subsidiaries of a distributor may use different techniques for tracking products information. A first subsidiary (e.g., which is responsible for distribution in a particular territory) may use a single database to track information across all distribution centers, while a second subsidiary (e.g., response for distribution in a different territory) may use separate databases to track information for each distribution center.

In some embodiments, server 402 can communicate with one or more distributor database servers 410 to collect information about products that can be ordered via the distributor associated with the database. In some embodiments, server 402 can collect information about a particular distributor (or distributors) into a single encrypted database (e.g., database 304 described above in connection with FIG. 3A). In some embodiments, computing device 430 can communicate with server 402 to retrieve information about a particular distributor. For example, computing device 430 can be used to present a user interface that can be used to initiate queries to server 402 related to the distributor, such as which products are available via a particular distribution center, which products are available across a set of distribution centers (e.g., all distribution centers associated with the distributor), price information, and any other suitable information.

In some embodiments, communication network 420 can be any suitable communication network or combination of communication networks. For example, communication network 420 can include a Wi-Fi network (which can include one or more wireless routers, one or more switches, and the like), a peer-to-peer network (e.g., a Bluetooth network), a cellular network (e.g., a 3G network, a 4G network, a 5G network, and the like, complying with any suitable standard(s), such as CDMA, GSM, LTE, LTE Advanced, WiMAX, 5G NR, and the like), a wired network, and the like. In some embodiments, communication network 420 can be a local area network, a wide area network, a public network (e.g., the Internet), a private or semi-private network (e.g., a corporate or university intranet), any other suitable type of network, or any suitable combination of networks. Communications links shown in FIG. 4 can each be any suitable communications link or combination of communications links, such as wired links, fiber optic links, Wi-Fi links, Bluetooth links, cellular links, and the like. In some embodiments, server 402 and/or computing device 430 can be any suitable computing device or combination of devices, such as a desktop computer, a laptop computer, a smartphone, a tablet computer, a wearable computer, a server computer, a virtual machine being executed by a physical computing device, and the like.

In some embodiments, communications transmitted over communication network 420 and/or communication links shown in FIG. 4 can be secured using any suitable technique or combination of techniques. For example, in some embodiments, communications transmitted to and/or from server 402, computing device 430, and/or database server 410 can be encrypted using any suitable technique or combination of techniques. For example, communication between two or more computing devices associated with communication network 420 (e.g., server 402, computing device 430, database server 410, Domain Name System (DNS) servers, one or more intermediate nodes that serve as links between two or more other devices, such as switches, bridges, routers, modems, wireless access points, and the like) computing devices can be carried out based on Hypertext Transfer Protocol Secure (HTTPS). As another example, communications can be carried out based on Transport Layer Security (TLS) protocols and/or Secure Sockets Layer (SSL) protocols. As yet another example, communications can be carried out based on Internet Protocol Security (IPsec) protocols. As still another example, a virtual private network (VPN) connection can be established between one or more computing devices associated with computing network 420. In some embodiments, one or more techniques can be used to limit access to communication network 420 and/or a portion of communication network 420. For example, computing devices attempting to connect to the network and/or transmit communications using the network can be required to provide credentials (e.g., a username, a password, a hardware-based security token, a software-based security token, a one-time code, any other suitable credentials, or any suitable combination of credentials).

In some embodiments, one or more security techniques can be applied to any suitable portion of a communication network that interacts with computing devices. For example, security techniques can be used to implement a secure Wi-Fi network (which can include one or more wireless routers, one or more switches, and the like), a secure peer-to-peer network (e.g., a Bluetooth network), a secure cellular network (e.g., a 3G network, a 4G network, a 5G network, and the like, complying with any suitable standard(s), such as CDMA, GSM, LTE, LTE Advanced, WiMAX, 5G NR, and the like), and the like.

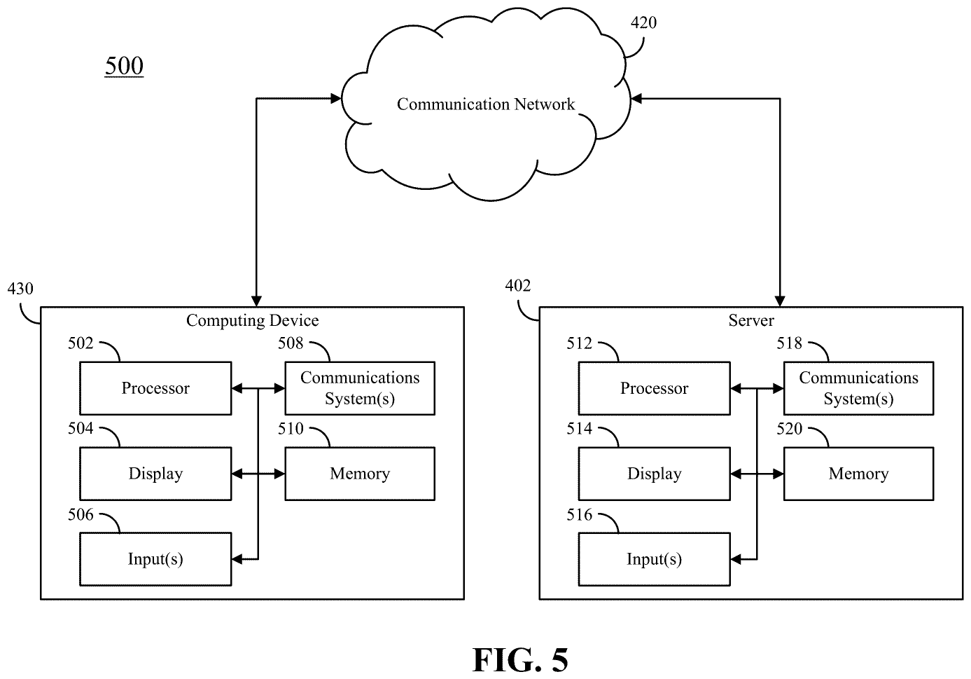

FIG. 5 shows an example 500 of hardware that can be used to implement server 402 and computing device 430 in accordance with some embodiments of the disclosed subject matter. As shown in FIG. 5, in some embodiments, computing device 430 can include a processor 502, a display 504, one or more inputs 506, one or more communication systems 508, and/or memory 510. In some embodiments, processor 502 can be any suitable hardware processor or combination of processors, such as a central processing unit (CPU), a graphics processing unit (GPU), and the like. In some embodiments, display 504 can include any suitable display devices, such as a computer monitor, a touchscreen, a television, and the like. In some embodiments, inputs 506 can include any suitable input devices and/or sensors that can be used to receive user input, such as a keyboard, a mouse, a touchscreen, a microphone, a camera, and the like.

In some embodiments, communications systems 508 can include any suitable hardware, firmware, and/or software for communicating information over communication network 420 and/or any other suitable communication networks. For example, communications systems 508 can include one or more transceivers, one or more communication chips and/or chip sets, and the like. In a more particular example, communications systems 508 can include hardware, firmware and/or software that can be used to establish a Wi-Fi connection, a Bluetooth connection, a cellular connection, an Ethernet connection, and the like.

In some embodiments, memory 510 can include any suitable storage device or devices that can be used to store instructions, values, and the like, that can be used, for example, by processor 502 to present content using display 504, to communicate with server 402 via communications system(s) 508, and the like. Memory 510 can include any suitable volatile memory, non-volatile memory, storage, or any suitable combination thereof. For example, memory 510 can include RAM, ROM, EEPROM, one or more flash drives, one or more hard disks, one or more solid state drives, one or more optical drives, and the like. In some embodiments, memory 510 can have encoded thereon a computer program for controlling operation of computing device 430. In such embodiments, processor 502 can execute at least a portion of the computer program to present content (e.g., user interfaces, tables, graphics, and the like), receive content from server 402, transmit information to server 402, and the like.

In some embodiments, server 402 can be implemented using one or more servers 402 (e.g., functions described as being performed by service 402 can be performed by multiple servers acting in concert) that can include a processor 512, a display 514, one or more inputs 516, one or more communications systems 518, and/or memory 520. In some embodiments, processor 512 can be any suitable hardware processor or combination of processors, such as a CPU, a GPU, etc. In some embodiments, display 514 can include any suitable display devices, such as a computer monitor, a touchscreen, a television, and the like. In some embodiments, inputs 516 can include any suitable input devices and/or sensors that can be used to receive user input, such as a keyboard, a mouse, a touchscreen, a microphone, and the like. In some embodiments, server 402 can be a mobile device.

In some embodiments, communications systems 518 can include any suitable hardware, firmware, and/or software for communicating information over communication network 420 and/or any other suitable communication networks. For example, communications systems 518 can include one or more transceivers, one or more communication chips and/or chip sets, and the like. In a more particular example, communications systems 518 can include hardware, firmware and/or software that can be used to establish a Wi-Fi connection, a Bluetooth connection, a cellular connection, an Ethernet connection, and the like.

In some embodiments, memory 520 can include any suitable storage device or devices that can be used to store instructions, values, and the like, that can be used, for example, by processor 512 to present content using display 514, to communicate with one or more computing devices 430, and the like. Memory 520 can include any suitable volatile memory, non-volatile memory, storage, or any suitable combination thereof. For example, memory 520 can include RAM, ROM, EEPROM, one or more flash drives, one or more hard disks, one or more solid state drives, one or more optical drives, and the like. In some embodiments, memory 520 can have encoded thereon a server program for controlling operation of server 402. In such embodiments, processor 512 can execute at least a portion of the server program to transmit information and/or content (e.g., results of a database query, a portion of a user interface, textual information, graphics, and the like) to one or more computing 430, receive information and/or content from one or more computing devices 430, receive instructions from one or more devices (e.g., a personal computer, a laptop computer, a tablet computer, a smartphone, and the like), and the like.

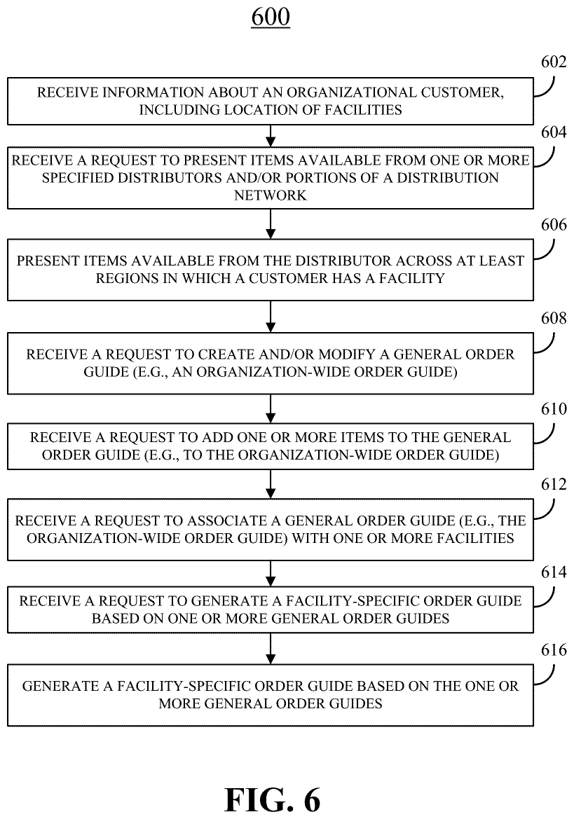

FIG. 6 shows an example 600 of a process for creating and using an order guide (e.g., a general order guide that can be associated with one or more facilities associated with an organization) to procure items for one or more facilities in accordance with some embodiments of the disclosed subject matter. As shown in FIG. 6, at 602, process 600 can receive information about an organization that is associated with one or more facilities. Note that information about an organization, such as information received at 602, can be considered organization metadata. In some embodiments, the information about the organization can include any pertinent information. For example, the information about the organization can include identifying information of a group purchasing organization(s) that the organization is associated with (if any). As another example, the information about the organization can include locations (e.g., at any suitable level of generality, such as street address, zip code, municipality, state, and the like) of various facilities to which deliveries may be made (e.g., by a distributor). As yet another example, the information about the organization can include identifying information associated with each of the various facilities (e.g., a semantically meaning name) associated with the organization that a user may wish to associate with an order guide. In some embodiments, process 600 can receive the information about the organization via a user interface (e.g., presented by computing device 430). Additionally, or alternatively, in some embodiments, process 600 can receive the information about the organization as a file or stream of information. For example, process 600 can receive a file that includes details about the organization in a file with any suitable format, such as a comma-separated values (CSV)-based format, a tab-separated values (TSV)-based format, a fixed-length-based format, an Extensible Markup Language (XML)-based format, or the like. As another example, process 600 can receive the information in connection with one or more instructions (e.g., a WRITE instruction, an INSERT instruction, an UPDATE instruction, and the like).

In some embodiments, the information associated with the organization received by process 600 can include information about rebates, discounts, or other arrangements that the organization can utilize, the terms of such arrangements, identifying information of the other party in the arrangement (e.g., a supplier, a distributor, a third party, and the like), and/or any other suitable information.

In some embodiments, the information associated with the organization received by process 600 can include information about one or more distributors that the organization may use to procure items for its facilities. For example, if process 600 is executed as part of a service provided by a third party (e.g., not the organization, a particular distributor, nor a supplier) the service may be configured to facilitate ordering with multiple distributors, potentially associated with different categories of items. In such an example, at 602, process 600 can receive information about which distributor(s) in particular the organization may order from, which can include distributors across different categories of products (e.g., food, office supplies, medical supplies, janitorial supplies, etc.). As another example, if process 600 is executed as part of a service provided by a particular distributor, the information associated with the organization received by process 600 may omit information about which distributor the organization is interested in ordering items from.

In some embodiments, the information associated with the organization received by process 600 can include information about the organization's behavior over time. For example, the information can include information about items that the organization (e.g., via various facilities) has purchased over any suitable period of time. In some embodiments, such information can be provided explicitly by a user associated with the organization (e.g., in the form of a file that includes historical information) and/or can be provided programmatically (e.g., a user can cause such information to be automatically shared with process 600 as the organization purchases products).

At 604, process 600 can receive a request to present items available from a specified distributor or distributors, and/or items available in one or more specified portions of a distribution network that includes one or more distributors. In some embodiments, the request can be received in any suitable form. For example, an application executed by a computing device associated with the organization can receive input indicating that items available from a specified distributor are to be presented, which can cause the computing device to request information that can be used to present a user interface that includes items available from the specified distributor. Such an application can be an order management application executed by the operating system of the computing device, an application accessed remotely such as via a web browser (e.g., a web application), or any other suitable type of application. In such an example, the input can be a selection of a particular user interface element associated with the specified distributor, a selection of a user interface element for initiating creation and/or editing of an order guide associated with the specified distributor, or any other suitable input.

In some embodiments, process 600 can utilize data requests that conform to one or more Electronic Data Interchange (EDI) standards to request availability and inventory (e.g., EDI 846, Inventory Inquiry/Advice). Additionally, or alternatively, in some embodiments, process 600 can utilize one or more custom web services (e.g., a RESTful web service that is configured to provide interoperability between systems associated with a particular supplier and/or distributor and systems associated with process 600, such as order management system 302). In some embodiments, process 600 can utilize a custom application program interface (API) that facilitates communication between systems associated with process 600 (e.g., as order management system 302) and systems associated with one or more suppliers and/or distributors, which can be utilized to query such systems, and/or to transfer data and information. In some embodiments, process 600 can cause item/location information to be stored in a unified database (e.g., representing a master catalog) for each supplier and/or distributor, which can be used to present such information to an organization/user via a user interface. In some embodiments, one or more security measures can be used to protect information in the unified database, such as by encrypting the information, requiring that a user provide credentials (e.g., a username, a password, a token, a one-time code, and/or any other suitable credentials) associated with an authorized user in order to access the information in the unified database, requiring that a computing device attempting to access the unified database is associated with a particular domain, and/or any other suitable security measures. In some embodiments, any suitable technique or combination of techniques can be used to protect the information in the database by encrypting data stored in the database. For example, techniques associated with Advanced Encryption Standard (AES) can be used to encrypt data stored in the unified database. As another example, techniques associated with Full Disk Encryption, File Encryption, can be used to encrypt data stored in the database by applying encryption to one or more disk volumes used to store the data. Additionally, in some embodiments, process 600 can cause pricing information to be stored in a separate data structure for each organization. For example, in some embodiments, pricing information can be stored in a table of a database that is associated with the organization (e.g., a relational database, or a non-relational database). In such an example, each organization can be associated with a separate table. Alternatively, multiple organizations can be associated with a single table that uses identifying information associated with the organization in a key (e.g., a primary key) associated with the price information. As another example, each price can be associated with a primary key that includes identifying information associated with the distributor (e.g., a distributor name, a distributor identification number, a distribution center name, and/or a distribution center identification number), identifying information associated with the product (e.g., a product name, and/or a product identification number such as a SKU or UPC), identifying information associated with the organization (e.g., a name associated with the organization, an identification number associated with the organization), and/or any other suitable information. As yet another example, each organization can be associated with a file that includes a list of prices associated with the organization.

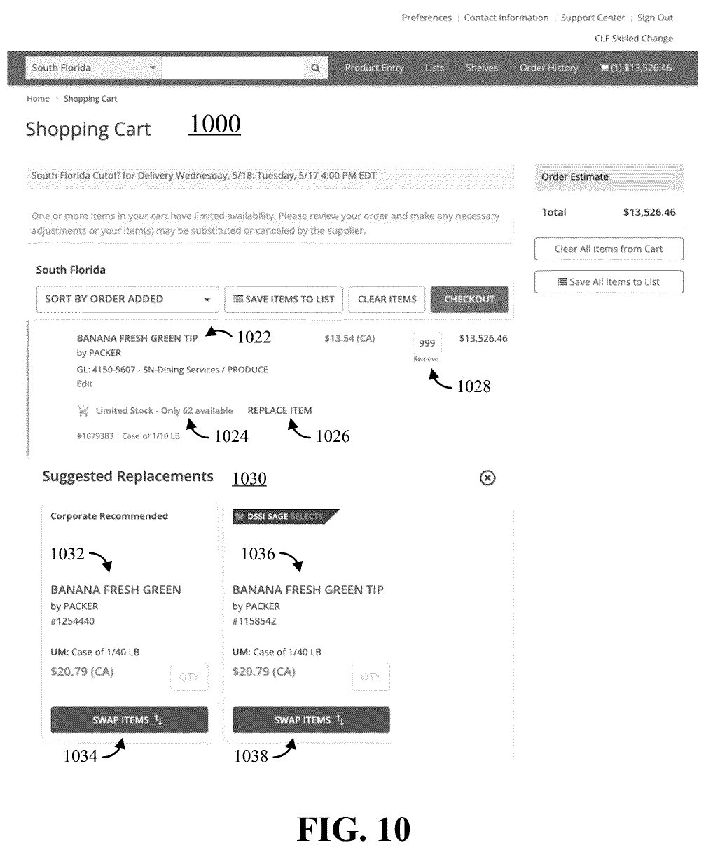

At 606, process 600 can cause a computing device associated with the organization to present a user interface that includes information related to items available from the distributor. In some embodiments, process 600 can make available information related to the items available from the distributor in multiple regions or other subnetworks in which a facility associated with the organization is located. In some embodiments, the items can be presented in any suitable format. For example, the items can be presented as a list in any suitable order based on one or more properties associated with the item (e.g., alphabetical by name, alphabetical by brand, by category, by price, and the like). As another example, the items can be presented as a frontend of a searchable database with one or more input fields for providing search terms, a field that can be used to present results, and/or any other suitable user interface elements. For example, the items can be presented using a search user interface, such as the user interface shown in and described below in connection with FIG. 10F.

In some embodiments, any suitable information can be used to identify items that are available from the distributor, such as text (e.g., a name of the item, a description of the item, specifications of the item, and the like), one or more images (e.g., images of the item, images of branding associated with the item, and the like), and/or any other suitable information. In general, information associated with an item can be referred to as item metadata, or metadata associated with the item. Such metadata can include any suitable information that can be used to identify the item, describe the item, and/or retrieve information about the item. Additional examples of metadata can include a brand associated with the item, the size of an item, a number of items included in a package, a unit of measure associated with the item, a SKU, a UPC, a price associated with the item, one or more attributes of the item, and a category associated with the item. Note this is not an exhaustive list of every type of information that can be considered item metadata.

In some embodiments, the mechanisms described herein can be used to generate an order guide that includes services and/or includes only services. In such embodiments, in addition to, or in lieu of, presenting items available from a distributor, and adding such items to an order guide that can be used to facilitate procurement, the mechanisms described herein can present one or more services that are available from service providers, and such services can be added to an order guide. For example, bottled water delivery via various providers can be added as a “product group” (although it is generally a service) to an order guide, to facilitate procurement of such a service by individual facilities.

At 608, process 600 can receive a request to create and/or modify an order guide to be associated with the organization. Such an order guide is sometimes referred to herein as a general order guide, and can be referred to using other terms, such as a generic order guide, a corporate order guide, an organization order guide, an organization-wide order guide, a master order guide, a central order guide, a product catalog, a service catalog, a shopping list, a bid, a formulary, a preferred list, a recommended list, or the like. Note that some terms may have special meanings within particular industries, and the preceding list is intended to supplement such meanings, rather than providing a limiting definition of such terms. In some embodiments, such a request can be initiated in response to any suitable action. For example, such a request can be initiated in response to selection of a user interface element associated with creation of a new general order guide (e.g., an icon labeled “create new order guide”, an element of a menu labeled “create new order guide”). As another example, such a request can be initiated in response to selection of a user interface element associated with editing an existing general order guide (e.g., an icon labeled “edit an order guide”, an element of a menu labeled “edit an order guide”, an icon associated with an existing general order guide, and the like). As still another example, such a request can be initiated in response to selection of a user interface element associated with an item (e.g., an icon labeled “save”, “add”, “add to order guide”, “authorize”, “+”, and the like; an element of a menu that is similarly labeled, and the like). In such an example, in response to selection of such a user interface clement associated with a particular item, if a general order guide is not currently selected, process 600 can cause the user to be prompted to select an existing general order guide and/or create a new order guide to which the item is to be added. The user can assign certain priorities when creating or modifying an order guide, such that certain products and/or groups of products are defined as having higher or lower priority relative to others. Moreover, the user can define acceptable alternatives to certain products and/or groups of products when creating or modifying an order guide. This information from the order guide can be used for product substitution functionality, as discussed in further detail below.

At 610, process 600 can receive a request to add one or more items to the general order guide selected and/or created at 608. In some embodiments, such a request can be in any suitable format. For example, such a request can be initiated by selection of a user interface element associated with the item (e.g., an icon labeled “save”, “add”, “add to order guide”, “authorize”, “+”, and the like), and an application presenting the user interface element can cause identifying information of the item to be transmitted to a device executing process 600. As another example, such a request can be received via a command line interface (e.g., as a series of identifying information associated with one or more items to be added to the general order guide, such as a stock keeping unit (SKU) associated with the item, a Universal Purchase Code (UPC) associated with the item, a Uniform Resource Identifier (URI) associated with the item, a Uniform Resource Locator (URL) associated with the item, a Global Trade Identity Number (GTIN), and/or any other identifying information). As yet another example, such a request can be received via an application program interface (API).

At 612, process 600 can receive a request to associate a general order guide with one or more facilities. For example, a user can create multiple general order guides and assign one or more of the general order guides to each facility associated with the organization. In such an example, the user can create different general order guides that suit the needs of facilities with different needs and/or that are associated with different activities that a facility may perform, and can associate the general order guides with the particular facilities. As a more particular example, if the organization is associated with multiple different types of facilities (e.g., hospitals, outpatient clinics, hospice facilities, nursing homes, and the like), the user can assign each facility one or more order guides. As another more particular example, if a facility is associated with different services (e.g., a hotel that provides breakfast for guests, and that operates a restaurant), the user can assign that facility one or more order guides corresponding to the services provided by the facility. In some embodiments, facilities can be organized into groups and/or into a hierarchy. For example, a user can assign a facility to one or more groups of facilities. As another example, a facility can be added to a group programmatically (e.g., without any user intervention). In such an example, facilities can be added to a group based on one or more characteristics of the facility or facilities. Such characteristics can include location of the facility, the type of facility (e.g., hospitals can be added to a first group, nursing homes can be added to a second group), the name of the facility, whether facilities have been associated with the same general order guides, operating characteristics of a facility (e.g., hours, whether the facility is in a building that is owned by the organization or leased), and/or any other characteristics. As yet another example, groupings of facilities can be suggested based on one or more characteristics of the facility or facilities.

In some embodiments, a general order guide can be associated with a group and/or with an individual facility. For example, if a user associates a general order guide with a group, whether the general order guide is used when generating a facility order guide can be determined based on whether the facility is associated with the group. In such an example, if a particular facility is added to a group after a general order guide is associated with the group, the general order guide can be used when generating an order guide for the facility. Similarly, if a particular facility is included in a group when a general order guide is associated with the group, but the facility is later removed, the general order guide can be excluded from consideration when generating a facility order guide for the facility. As another example, a single general order guide can be associated with a group, and with a facility included in the group. In such an example, the general order guide can be used when generating an order guide for the facility regardless of the current group membership status of the facility.

At 614, process 600 can receive a request to generate a facility-specific order guide that includes one or more items from one or more general order guides associated with the facility (e.g., at 612). In some embodiments, such a request can be in any suitable format. For example, such a request can be initiated after a user has associated one or more general order guides with a particular facility. As another example, such a request can be initiated when a user finishes associating one or more general order guides with a facility (e.g., by selecting a user interface clement to save the associations, by navigating to another portion of the user interface, or the like). As yet another example, such a request can be initiated when a user accesses a user interface associated with a particular facility, such as to review an order guide associated with the facility, to create an order for the facility, or for any other suitable purpose.

At 616, process 600 can automatically create an order guide associated with the facility based on the one or more general order guides associated with the facility. Note that the order guide associated with the facility is sometimes referred to herein as a facility order guide, and can be referred to as a facility-specific order guide, an ordering location order guide, a local order guide, an auxiliary order guide, a secondary order guide, a peripheral order guide, a specific order guide, a local product catalog, a local service catalog, a facility bid, a facility formulary, a facility preferred list, a facility recommended list, or the like. Additionally, in some cases, the phrase order guide is used to refer to both an order guide associated with an organization (generally referred to herein as a general order guide) and order guides associated with various portions of the organization (generally referred to herein as a facility order guide) that are generated based on an order guide associated with the organization. This combination of terms was generally not used herein in the interest of clarity. In some embodiments, the order guide associated with the facility can include items from each of the general order guides associated with the facility. Additionally, in some embodiments, if multiple general order guides include the same item, process 600 can include only a single instance of the item in the facility order guide.

Alternatively, in some embodiments, process 600 can include each instance of the item from the general order guides in the facility order guide. In some embodiments, duplicated items in a facility order guide can be removed during an ordering process (e.g., when the facility order guide is submitted to a procurement service or application). In some embodiments, the facility order guide can be formatted in any format that is suitable for presentation and/or submission to an application and/or service that can be used to place an order with one or more distributors based on the facility order guide. For example, the facility order guide can include information such as identifying information associated with the organization, identifying information associated the facility, identifying information of one or more general order guides used to generate the facility order guide, identifying information of one or more items, identifying information of one or more master items or product groups associated with the items, and any other suitable information. As described below, in some embodiments, particular items that are included in the facility order guide can be selected from a list of acceptable alternatives (e.g., sometimes referred to herein as a master list, or a product group) at the time the order guide is created based on any suitable factors such as stated preference, availability, price, size, brand, and the like.

In some embodiments, process 600 can utilize any suitable technique or combination of techniques to determine price and/or availability at the time when an order is being created. For example, process 600 can utilize techniques described above in connection with 606. In some embodiments, process 600 can query one or more systems associated with a particular distributor associated with the order to obtain updated price and availability information in real time (or near real time). In some embodiments, if such information is not available or otherwise cannot be obtained in real time, process 600 can use stored price information and can reconcile available inventory information after the order is accepted by the distributor. In some embodiments, information about backorders and discontinued items can be communicated to an organization and/or user at any suitable time. For example, such information can be communicated to the organization in a separate process. As another example, such information can be presented via a user interface or API used to place an order.

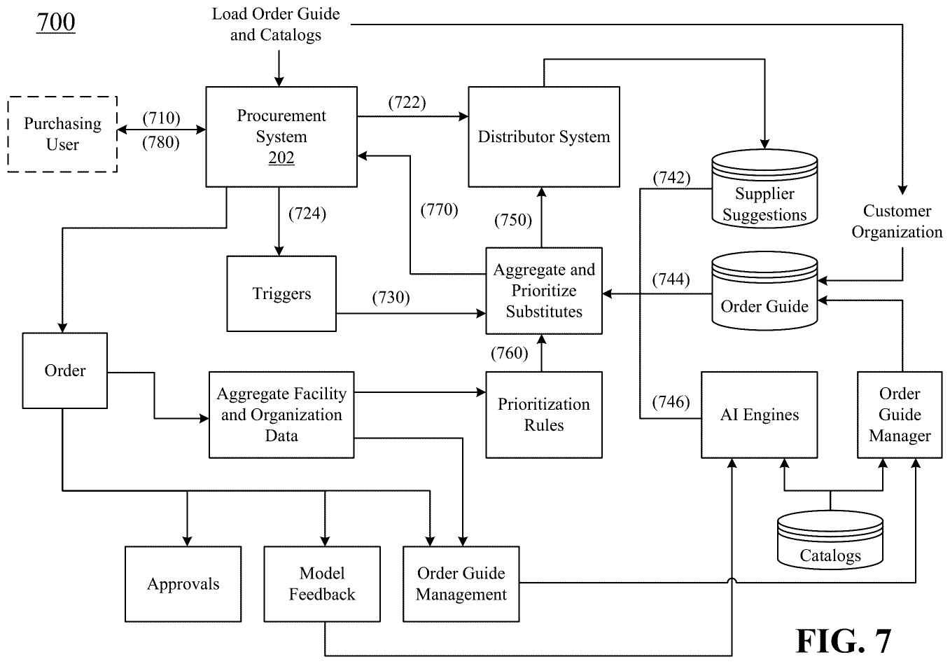

FIG. 7 shows an example system 700 for optimizing ordering events within a procurement system in accordance with some embodiments of the disclosed subject matter. For example, the procurement system can be procurement system 202 as discussed above, or another similar type of procurement system. System 700 and the associated data flow as illustrated in FIG. 7 allows for optimizing ordering events within procurement system 202 with product substitutions that are generated using data that the purchasing user (orderer) does not have immediate access to and/or cannot efficiently process at scale in order to generate meaningful recommendations and order placing functionality. While some of the functions discussed with respect to FIG. 7 are described as being performed by procurement system 202, it will be appreciated that in some embodiments some or all of the steps can be performed by and/or in connection with one or more additional systems, such as order management system 302, order management service 404, and/or inventory management service 406, for example. FIG. 7 illustrates data flow within system 700 in a series of numbered steps as detailed below.

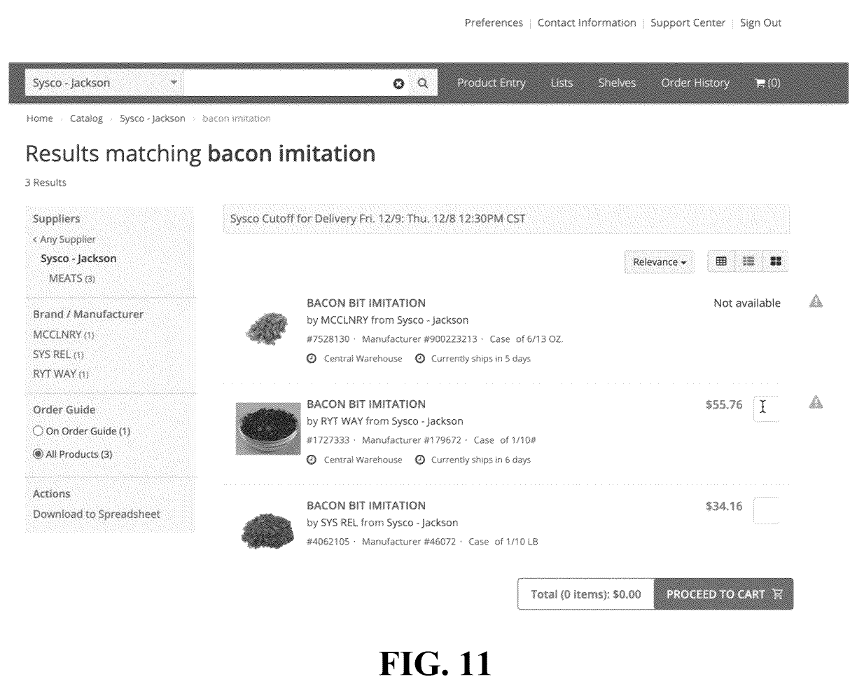

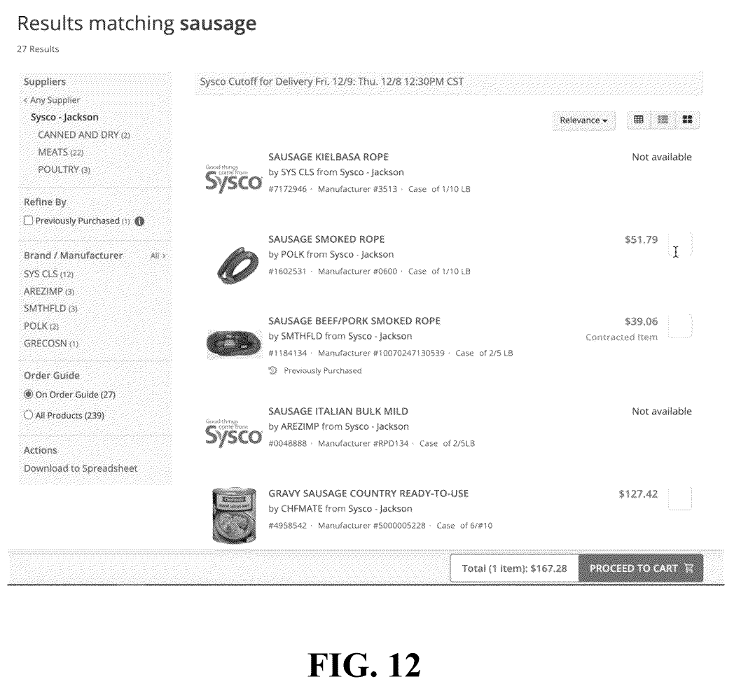

At 710, a purchasing user can select one or more products available via procurement system 202. Different products for selection by the purchasing user can be populated within procurement system 202 by loading one or more order guides and/or one or more catalogs, for example. The order guides and catalogs can be referred to using terms such as a generic order guide, a corporate order guide, an organization order guide, an organization-wide order guide, a master order guide, a central order guide, a product catalog, a service catalog, a shopping list, a bid, a formulary, a preferred list, a recommended list, or the like. The purchasing user can also select a quantity associated with each of the selected products. The user can select products and associated quantities in procurement system 202 via a user interface such as shown in FIG. 11 and FIG. 12, as discussed below. The purchasing user can search for different types of products, filter products according to different properties and attributes (e.g., brand, supplier, etc.), and perform other types of actions to efficiently find and select products.

At 722, procurement system 202 can check the real-time availability of the one or more selected products (for the distribution network that the facility is geographically located within), for example by querying one or more different distributor systems associated with the one or more selected products (e.g., querying distributor server 410). Procurement system 202 can then use the information regarding the real-time availability of the one or more selected products to provide feedback to the purchasing user in the event that data retrieved from any of the one or more distributor systems indicates a potential problem with availability for the one or more selected products. Distributor systems can manage data regarding availability of products in a variety of manners. For example, distributor database server 410 can be used to manage a distributor database that includes information about multiple distribution centers associated with a single distributor. A particular distributor may also use a single database to track products across multiple distribution centers, while a different distributor may use a different database to track products for each distribution center, among other possible methods for managing product availability data.

At 724, procurement system 202 can evaluate the one or more products selected by the purchasing user relative to one or more triggers. For example, procurement system 202 can use the real-time availability data regarding the one or more products selected by the purchasing user to evaluate the one or more products selected by the purchasing user relative to one or more triggers. The one or more triggers can be used to determine whether procurement system 202 should suggest one or more substitute items corresponding to one or more of the selected items to the purchasing user. A variety of different types of triggers can be used depending on the implementation. For example, one or more triggers for driving order guide compliance can be implemented to provide substitute product recommendations when the purchasing user selects items that are not on an order guide (e.g., an order guide loaded into procurement system 202). One or more triggers for driving cost savings and margin optimization can also be implemented to provide substitute recommendations when the purchasing user selects items that do not meet certain financial goals for an organization, a facility, or the like. One or more triggers for spend tracking against budgets and minimum spending levels (e.g., for grants, subsidies, incentives, etc.) can also be implemented in order to drive compliance with additional financial goals for an organization, a facility, or the like. One or more triggers that are based on supplier characteristics (e.g., women-owned, or minority-owned business enterprise (WMBE), etc.) can also be implemented, in addition to one or more triggers that are based on census data for one or more facilities (e.g., number of residents, etc.). The one or more triggers can also be based on approval history (e.g., ordering of a product that has previously been declined by an approval user, such as, for example, off-order guide products). The one or more triggers can also be based on supplier information including, for example, supplier/distributor inventory levels, replenishment rates, forecasting models, supplier product expiration information, supplier product time in inventory information, supplier drop size information, brand incentive information, and/or customer order guide selections. The one or more triggers can also be based on corporate supplier preference configurations (e.g., as entered via a user interface).

At 730, potential substitute products that can replace one or more of the selected products can be requested responsive to one or more triggers being activated based on one or more selected products. For example, procurement system 202 can request potential substitute products from a separate system such as order management system 302. Procurement system 202 can also query one or more databases, including databases associated with procurement system 202, in order to request potential substitute products. As part of the request or requests, procurement system 202 can include some type of identifier associated with the one or more selected products (e.g., SKU, etc.) in order to provide a valid request for potential substitute products. Procurement system 202 can also provide one or more attributes associated with the one or more selected products (e.g., quantity, distributor, order guide status, item grouping, tags, etc.) as part of the request.

At 742, supplier suggestions for substitute products that can be presented as replacement options to the user can be received. For example, supplier suggestions can be obtained by querying distributor server 410, or procurement system 202 may use an otherwise available list of supplier suggestions. In one example, updated supplier suggestions can be provided via a data file feed periodically (e.g., daily) or upon request (e.g., a file can be sent via FTP, AS2, or equivalent file sharing protocol). Alternatively, an API integration with the supplier system (e.g., the distributor server 410) can be used to obtain the supplier suggestions. Depending on the specific order guide(s) and/or catalog(s) loaded into procurement system 202 for a given purchasing user, the supplier suggestions can vary. As an example, in the event a given supplier currently is out of stock or has limited stock of a given product (e.g., a first brand of tomato sauce), the supplier can provide alternatives to the given product that can also be provided by the same supplier (e.g., a second brand of tomato sauce). The use of supplier suggestions in generating substitute recommendations can provide efficiencies not only for purchasing users, but also for suppliers that sell products via procurement system 202.

At 744, potential substitute products as defined via one or more order guides associated with the purchasing user can be received. For example, as discussed, a given order guide for a facility can include a list of acceptable alternatives for different products on the order guide. Procurement system 202 can analyze the order guide to first determine if a selected product is on the order guide, and then determine if the order guide includes any acceptable alternatives for the selected product. In this manner, procurement system 200 can facilitate order guide compliance by providing substitute recommendations that are consistent with the order guide for a given organization and/or facility. Order guide compliance can provide a variety of different benefits, including cost efficiency, resident satisfaction, supplier satisfaction, and other possible benefits.

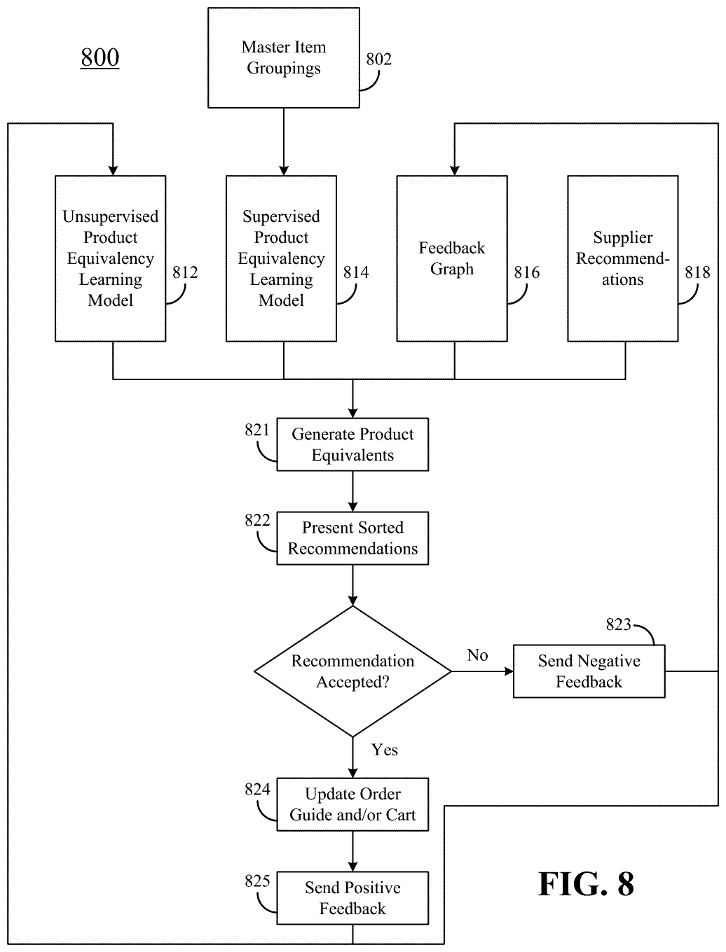

At 746, potential substitute products from one or more artificial intelligence (AI) engines can be received. The artificial intelligence engines can dynamically generate substitute product recommendations based on historical substitution data, historical order data, user response and feedback data, and other types of data. For example, the artificial intelligence engines can be implemented using various different types of machine learning algorithms and approaches, including use of one or more supervised machine learning models and/or use of one or more unsupervised machine learning models. Other approaches including semi-supervised learning, deep learning, and other similar approaches can be used to dynamically identify potential substitute products associated with a given selected product. Some example product equivalency learning models are discussed in more detail below with respect to FIG. 8.

At 750, the availability of potential substitute products identified at 742, 744, and/or 746 can be checked within a distribution network associated with the purchasing user. For example, procurement system 202 can check the real-time availability of potential substitute products by querying one or more different distributor systems associated with the potential substitute products (e.g., querying distributor server 410). Procurement system 202 can then use the information regarding the real-time availability of the potential substitute products to eliminate any of the potential substitute products that are not available within distribution network associated with the purchasing user. As noted, distributor systems can manage data regarding availability of products in a variety of manners, including use of a single database or use of multiple databases.

At 760, the potential substitute products can be aggregated and prioritized (ranked) in a variety of manners. For example, procurement system 202 can use different rules to prioritize potential substitute products based on defined corporate configurations or different system configurations. It can also be based on prioritizations for specific equivalent product groups (i.e., master item groupings in the order guide) defined by the organization. The rules can be influenced in some cases by an associated trigger that causes the substitution evaluation to be performed as well as additional information that may be relevant to the prioritization of potential substitute products. For example, different rules can be created in order to drive budgeting efficiency, meeting spending goals, eliminate blocked items, drive order guide compliance, prioritize certain tags or suppliers associated with potential substitutes (e.g., on order guide, supplier characteristics, AI recommended, supplier recommended, cost savings, margin, etc.). In addition to rules, the ranking of potential substitute products can be performed more dynamically using different types of approaches to prioritizing potential substitute products including using machine learning to prioritize potential substitute products. Prioritization may also be based on quality, cost, margin, corporate prioritization of products, brand/supplier preference, etc. for the particular equivalent products. In some embodiments, different rules can be used to filter out potential substitute products based on defined corporate configurations or different system configurations including. In one example, the corporate configuration can include a rule to filter out supplier recommended products, unless they are recommended through another method. In another example, the corporate configuration can include a rule to filter out all but products that are provided on the order guide. This means the corporate office can pre-approve all substitute product options in advance. These corporate configurations can be configured for all managed facilities, or a subset of facilities managed by the organization. The potential substitute products can include mappings to equivalent products across suppliers (i.e., cross-vendor substitute products) that can be used to recommend products for a particular supplier.

At 770, the recommended substitute products can be loaded into procurement system 202. For example, the recommended substitute products and associated ranking as determined in step 760 can be loaded into procurement system 202 for presenting to the purchasing user. Each of the potential substitute products can include one or more tags identifying various details about the potential substitute product. At 780, the ranked potential substitute products can be presented to the purchasing user via the user interface, and the purchasing user can replace selected items with suggested substitute products before completing a checkout process, such that the purchasing user purchases at least one of the suggested substitute products instead of at least one of the selected products. For example, the top 3 ranked potential substitute products can be presented to the purchasing user on a shopping cart page such as shown and described below with respect to FIG. 10 and FIGS. 13-17. The shopping cart page can present an indication of the ranking, such as by ordering potential substitute products or visually indicating some kind of preference for different potential substitute products relative to others. Once the purchasing user completes the checkout process, procurement system 202 can place one or more orders with one or more distributors for the different items in the shopping cart purchased by the purchasing user.

Once an order is placed, a variety of data associated with the order can be used to improve the suggested substitute product identification process for future transactions, as well as to improve the broader procurement process as a whole. For example, as illustrated in FIG. 7, data associated with the order and any substitutions that were made as part of the order can be used as feedback to train one or more models (e.g., models 812 and 814 as detailed below, feedback graph 816 as detailed below, etc.). Moreover, data associated with the order can be used for purchase order approvals. Based on data associated with the order, a reason for replacing a selected product with a suggested substitute product can be inferred (e.g., due to stockout, limited stock, order guide compliance, etc.). Based on the reason, a purchase order for the substitute product can either be automatically generated and approved, or the purchase order can be provided to a second user (e.g., manager) distinct from the purchasing user that placed the order for approval. In some cases, if the purchase order requires approval by the second user, procurement system 202 may not place the order until it receives an approval of the purchase order from the second user.

Data associated with the order can also be used for order guide management. For example, if the purchasing user performs a substitution via the shopping cart page, the substitute product in some cases can be automatically added to an appropriate order guide as an acceptable alternative for the associated selected product. Other order guide actions can also be implemented, such as replacing products on an order guide with selected substitutes, removing selected products that are swapped out for substitutes from an order guide, updating different properties of an order guide such as financial-related (e.g., budgeting, targeted spend, etc.) properties, identifying order guide gaps for which a product needs to be added to the order guide to address the gap, providing alerts to managing users associated with order guides indicating any changes, etc. For example, if a product is repeatedly ordered that is off order guide, a signal can be generated to either add the product (or similar products) to the order guide, or the product can be blocked from being ordered through the order guide or corporate configurations. Further, a prioritized recommendation can be displayed requiring further action by order guide management (e.g., a corporate user) to resolve the recommendation. In some cases, the order guide actions can be driven at least in part based on the inferred reason for making the substitute.

Moreover, data associated with the order can be aggregated with additional orders across a facility and/or across an organization including multiple facilities to drive different insights. For example, aggregate order data including various different substitutions can be used to update prioritization (ranking) rules used to prioritize substitutes that are suggested to the purchasing user via the shopping cart page when using procurement system 202. For example, if a certain facility demonstrates a strong preference for a specific type of substitute (e.g., because residents prefer that substitute, or based on), the prioritization rules for that facility can be modified accordingly. Moreover, the aggregate facility and organization data can be used to drive different order guide actions, such as replacing items or adding preferred alternatives to order guides, among other possible order guide actions as discussed above. The data may be compared to other data including specified budgets, minimum spend thresholds, or incentive goals that are loaded, created, or otherwise inputted. The incentives and goals can be organization specific (e.g., tax strategies), can be based on a purchasing contract between multiple parties (e.g., between a supplier and the organization, or the supplier and the GPO), and/or can be based on a variety of additional types of goals and incentives. This data may be received from a connected third-party system (e.g., an accounting system). This can be accomplished through a systematic connection via an API integration. The aggregation of large quantities of order data including substitutes that are made via the shopping cart page within procurement system 202 can provide significant insights that can provide various efficiencies for facilities and organizations.

FIG. 8 shows an example process 800 for generating substitute product recommendations in accordance with some embodiments of the disclosed subject matter. Process 800 can be performed by one or more systems, such as procurement system 202 and/or order management system 302. Process 800 is shown to include use of an unsupervised product equivalency learning model 812, a supervised product equivalency learning model 814, a feedback graph 816, and supplier (distributor) recommendations 818. Also, process 800 is shown to include master item groupings 802 that can be provided as input to supervised product equivalency learning model 814 such that supervised product equivalency learning model 814 can use master item groupings 802 to determine potential substitute products that are associated with a given selected product. Master item groupings 802 can include groupings of different products for one or more facilities and/or organizations. For example, master item groupings 802 can define a “bananas” grouping including various similar types of bananas that can be ordered by a facility (e.g., bananas from different distributors, different types of bananas, etc.). Generally, different items within the same master grouping are similar and can be substituted for each other, however it will be appreciated that various types of item groupings can be configured for use in process 800 and more broadly. Master item groupings 802 can be compiled manually, semi-manually, or automatically, and can be used to train supervised product equivalency learning model 814, for example. Master item groupings can be defined in various ways and can be defined by a variety of entities, such as being defined by one or more order guides and/or being defined by a corporate entity.

Supervised product equivalency learning model 814 can be implemented in a variety of ways, including using different types and combinations of algorithms such as support-vector machines, decision trees, linear and/or logistic regression models, neural networks, and/or other similar types of supervised machine learning algorithms. Generally, supervised product equivalency learning model 814 can receive labeled data, including master item groupings 802, in order to learn a function that maps inputs (e.g., products selected by a purchasing user via procurement system 202) to outputs (e.g., potential substitute products that can replace the selected products). The more labeled data supervised product equivalency learning model 814 receives, the more accurately it can determine an appropriate function, and thereby the more accurately it can generate product equivalents for use in substitute recommendations. In some embodiments, supervised product equivalency learning model 814 is a deep learning model, such as a deep neural network (e.g., a neural network with multiple hidden layers). Each product can be associated with corresponding product data, for example, product title (i.e., short description), extended description, pack size, nutritional data, images, etc. that can also be used in determining product equivalents.

Unsupervised product equivalency learning model 812 can likewise be implemented in a variety of ways, including using different types of algorithms and networks such as clustering algorithms and/or anomaly detection algorithms. In contrast to supervised product equivalency learning model 814, unsupervised product equivalency learning model 812 does not receive labeled training data (e.g., master item groupings 802) and instead infers product equivalents based on different factors such as feedback received from purchasing users in response to substitution recommendations provided via procurement system 202. For example, unsupervised product equivalency learning model 812 can receive as input different types of selected products, associated substitute products, and relevant feedback from users regarding the associated substitute products. In this sense, in some scenarios unsupervised product equivalency learning model 812 can dynamically generate product equivalents for use in providing substitute recommendations in a different manner than supervised product equivalency learning model 814, and thereby can in some scenarios discover substitute recommendations different from those discovered by supervised product equivalency learning model 814.

Feedback graph 816 can generally be used to track user feedback in response to substitution recommendations. It will be appreciated that feedback graph 816 can be implemented in a variety of ways using different types and configurations of one or more data structures. For example, feedback graph 816 can be built off of nodes connecting different items where the number of accepted substitute recommendations associated with a given item is greater than the number of declined substitute recommendations associated with the item. That is, feedback graph 816 can be used to track both positive and negative feedback associated with different substitution recommendations. Feedback graph 816 can then be used for a variety of purposes, including for training supervised product equivalency learning model 814, generating inputs for providing to unsupervised product equivalency learning model 812, and evaluating product equivalents generated by unsupervised product equivalency learning model 812 and/or supervised product equivalency learning model 814 before providing substitution recommendations to users.

Supplier recommendations 818 can include any different types of product substitute recommendations or product substitute groupings provided by different suppliers/distributors. Supplier recommendations 818 can be obtained, for example, by querying distributor server 410. Depending on the specific order guide(s) and/or catalog(s) loaded into procurement system 202 for a given purchasing user, supplier recommendations 818 can vary. As an example, in the event a given supplier currently is out of stock or has limited stock of a given product, the supplier can provide alternatives to the given product that can also be provided by the same supplier. The use of supplier recommendations 818 in generating substitute recommendations can provide efficiencies not only for purchasing users, but also for suppliers that sell products via procurement system 202. The suppliers/distributor recommended substitute products also can help improve the product equivalency model and feedback graph by providing alternative options that when selected will provide positive feedback to improve the various models.

At 821, process 800 can generate product equivalents that can be used as potential substitute products for a given selected item. Process 800 can generate the product equivalents based on an output of unsupervised product equivalency learning model 812, an output of supervised product equivalency learning model 814, feedback graph 816, and/or supplier recommendations 818. Additionally, process 800 can identify product equivalents in other manners, such as by evaluating one or more order guides to identify acceptable alternatives indicated via the order guide. In this manner, process 800 can dynamically identify a variety of potential equivalents that can ultimately be substituted for the given selected product.

At 822, process 800 can sort and filter the identified product equivalents and present the sorted product equivalents to the user via a user interface. For example, the sorted product equivalents can be presented on shopping cart page 1000 as suggested replacements 1030, as shown in FIG. 10 and discussed below. Process 800 can use different rules to prioritize the product equivalents based on a variety of factors (e.g., prioritization rules or data for an organization, prioritization rules or data from a supplier, etc.). The rules can be influenced in some cases by an associated trigger that causes the substitution evaluation to be performed as well as additional information that may be relevant to the prioritization of potential substitute products. For example, different rules can be created in order to drive budgeting efficiency, meet spending goals, eliminate blocked items, drive order guide compliance, prioritize certain tags or suppliers associated with potential substitutes, etc. In addition to rules, the ranking of potential substitute products can be performed more dynamically using different types of approaches to prioritizing potential substitute products including using machine learning to sort the product equivalents. In addition, rules can include filtering product equivalents, such as filtering out all products that are off order guide (i.e., filter out supplier recommended products and/or filter out product equivalents determined using AI/ML models). In such an example, it can be a corporate configuration set or selected by the organization. The rules can also include filtering out equivalent products that are not available at one or more distribution centers that serve the facility. For example, the filtering can include determining the distribution centers that can serve the facility (e.g., by querying a database of connections between distribution centers and facilities), and then by determining products available at each distribution center serving the facility (e.g., by querying a database of products available at each distribution center).

At 823, if the user does not accept a recommendation to replace the selected item in the shopping cart with a recommended substitute item, a negative feedback signal can be generated and provided back to feedback graph 816. At 824, if the user does accept a recommendation to replace the selected item in the shopping cart with a recommended substitute item, an associated order guide and/or the shopping cart can be updated accordingly. At 825, also if the user does accept a recommendation to replace the selected item in the shopping cart with a recommended substitute item, a positive feedback signal can be generated and provided as feedback to unsupervised product equivalency learning model 812 and/or feedback graph 816. The process 800 can also include filtering and sorting based on user-specific information (e.g., particular facility or organization information) such as, for example, preferences, facility location, care type, market, bed count, financial health, etc.

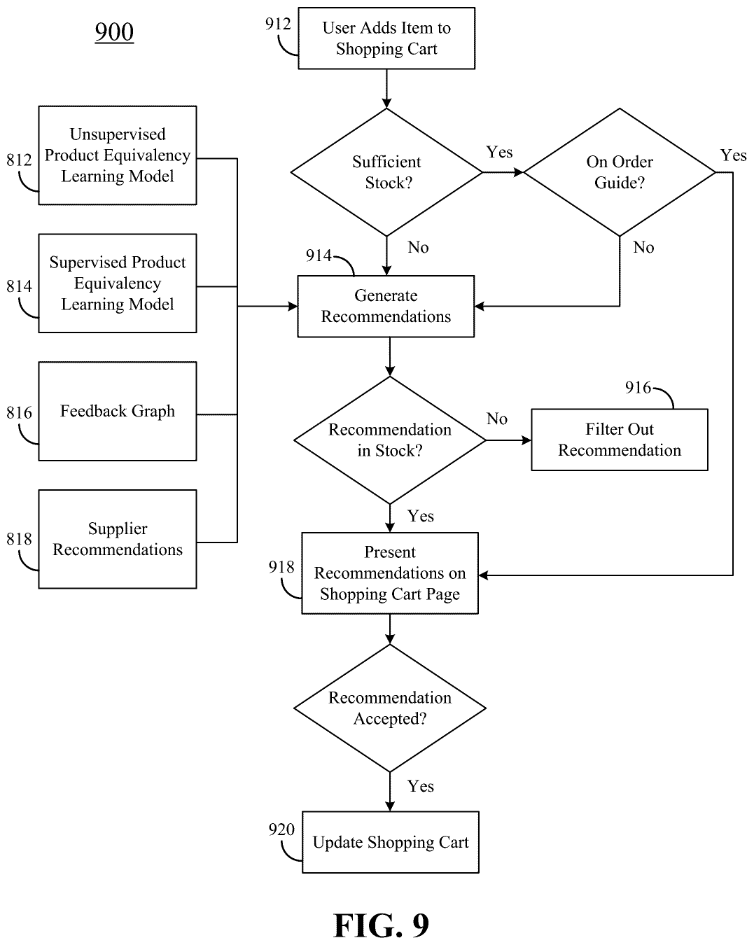

FIG. 9 shows an example process 900 for presenting and applying substitute product recommendations within a shopping cart user interface in accordance with some embodiments of the disclosed subject matter. Process 900 can be performed using one or more different systems, such as procurement system 202 and/or order management system 302. Process 900 is also shown to include use of unsupervised product equivalency learning model 812, supervised product equivalency learning model 814, feedback graph 816, and supplier (distributor) recommendations 818.

At 912, a user can add an item to a shopping cart via a user interface. For example, a user can search for products and add products that appear in a set of search results to a shopping cart. Then, the user can add a product that appears in the search results to the shopping cart for purchasing. If there is sufficient stock of the selected item and the selected item is on an associated order guide, then process 900 can proceed to 918. In some examples, depending on which triggers are implemented for substitution evaluations, process 900 can end after determining that there is sufficient stock of the selected item and that the selected item is on the associated order guide (e.g., no recommendations may be presented, and no updates to the shopping cart may be made). If there is sufficient stock of the selected item, but the selected item is not on an associated order guide, then process 900 can proceed to 914. If there is not sufficient stock of the selected item (e.g., stockout or limited stock), then process 900 can also proceed to 914.

At 914, recommended substitute items can be selected corresponding to the selected item. For example, process 900 can generate the recommended substitute items based on an output of unsupervised product equivalency learning model 812, an output of supervised product equivalency learning model 814, feedback graph 816, and/or supplier recommendations 818. Process 900 can also generate the recommended substitute items based on master item groupings/backups, either based on an output of supervised product equivalency learning model 814 or not based on supervised product equivalency learning model 814. In this example for process 900, the trigger for generating the recommended substitute items is either stockout, limited stock, or selection of an off order guide product, however other types of triggers are possible to cause performance of a substitution evaluation, as detailed herein.

If a recommended substitute item is not in stock or has limited stock available, then process 900 can proceed to 916. At 916, process 900 can filter out the recommended substitute item that is not in stock or has limited stock available. If a recommended substitute item is sufficiently stocked, then process 900 can proceed to 918. At 918, process 900 can present recommended substitute items to the user via the user interface. For example, the recommended substitute items can be presented to the user on shopping cart page 1000 as suggested replacements 1030, as shown in FIG. 10 and discussed below. If the user accepts at least one of the recommended substitute items, then process 900 can proceed to 920. At 920, process 900 can update the shopping cart by replacing the selected item with the accepted substitute item recommended to the user. In the case of limited stock, accepting at least one of the recommended substitute items, may only replace a quantity of the selected product equal to the selected quantity less the available quantity of the selected product. Process 900 can also take into account the unit of measurement (UOM or UM) of both the selected product and the substitute item when determining the equivalent quantity of the substitute item to replace the selected product. Alternatively, the net units of a case or pack of a product can be used when determining the equivalent quantity of the substitute item to replace the selected product. Although described for stockouts and limited stock, this can be done for any substitute product replacing a selected product if the unit of measure of one unit is different. In addition, process 900 may simply recommend a quantity for the substitute product that would be equivalent, which the user can override before making the replacement.

FIG. 10 shows an example shopping cart user interface that can efficiently facilitate product substitutions during procurement in accordance with some embodiments of the disclosed subject matter. Specifically, FIG. 10 shows an example shopping cart page 1000 that can be presented to a user such as a purchasing user of procurement system 202 via a user interface on a user device. Shopping cart page 1000 is shown to include a selected product identification 1022 as well as a selected quantity identification 1028. In the example shopping cart page 1000 shown in FIG. 10, the selected product is a case of fresh green tip bananas, and the user has selected a quantity of 999 cases of the fresh green tip bananas. Accordingly, selected product identification 1022 identifies the fresh green tip bananas, as well as various additional information associated with the fresh green tip bananas (e.g., supplier identification, product identifier, unit of measure, product type and/or grouping, etc.). Also, selected quantity identification 1028 identifies the selected quantity of 999 cases of the fresh green tip bananas.

Shopping cart page 1000 is also shown to include a warning 1024 associated with the selected product and a replace element 1026 associated with the selected product. Warning 1024 can be used to convey a variety of warnings about the selected product to the user, including indicating that the selected product has limited available stock, is out of stock, is off an order guide, etc. The warning 1024 can be a specific text, color, icon, image, etc. or combination thereof, used to convey a specific message. In the specific example shopping cart page 1000 as illustrated in FIG. 10, warning 1024 indicates that only a limited quantity of the selected green tip bananas (62) are currently available for purchasing. Warning 1024 can also include additional visual elements, such as a warning icon displayed in the lower right-hand corner of shopping cart page 1000. A variety of tags associated with the selected product can also be presented via shopping cart page 1000 in a similar manner as warning 1024, such as tagging a particular spend category, tagging the selected product as being on an order guide, and other possible types of tags. Replace element 1026 is a selectable user interface element that can be selected in order to facilitate a substitution of the selected product. Replace clement can facilitate substitution of the selected product in a variety of suitable manners.

Moreover, shopping cart page 1000 is shown to include suggested replacements 1030, including both a substitute product identification 1032 and a substitute product identification 1036. Substitute product identification 1032 identifies a similar but different case of fresh green bananas that can be substituted for the selected case of fresh green tip bananas. Substitute product identification 1036 likewise identifies a similar but different case of fresh green tip bananas that can be substituted for the selected case of fresh green tip bananas. The substitute products provided to the user via suggested replacements 1030 can be suggested as substitutes for a manner of reasons, as detailed herein, including corporate recommendations (e.g., to meet financial-related goals, for order guide compliance, etc.) and recommendations generated using artificial intelligence (e.g., using unsupervised product equivalency learning model 812 and/or supervised product equivalency learning model 814). Suggested replacements 1030 can be presented responsive to receiving a user selection of replace element 1026 or can be presented automatically responsive to activation of one or more triggers for performing a substitution evaluation.

Suggested replacements 1030 are advantageously presented on shopping cart page 1000 such that suggested replacements 1030 are in close proximity below selected product identification 1022. Moreover, shopping cart page 1000 is shown to include a swap clement 1034 associated with substitute product identification 1032 and a swap clement 1038 associated with substitute product identification 1036. Both swap clement 1034 and swap clement 1038 are selectable user interface elements that can be selected by the user based on an interaction between the user and the user interface (via the user device) in order to replace the selected product with the corresponding suggested substitute product. In this manner, the specific structure of shopping cart page 1000 can efficiently provide substitute product recommendations to the user such that the user does not have to navigate outside of the shopping cart page 1000 to view suggested replacements or to perform substitutions. Moreover, given the dynamic nature of the generation of suggested replacements 1030, use of shopping cart page 1000 during the procurement process can provide a variety of different advantages as detailed herein. In some cases, the substitute product presented may only be available for selection by a user through the suggested replacements 1030, for example, for a stockout or limited stock scenario of an on order guide product when an organization is configured to only allow the selection of on order guide products.

FIG. 11 shows an example user interface including search results for a first type of product in accordance with some embodiments of the disclosed subject matter. In the example shown in FIG. 11, the purchasing user has entered a search query for “bacon imitation” to search for bacon imitation products. Via the user interface, the user can sort and otherwise manipulate the search results in a variety of manners, including sorting by relevance, displaying different views of the search results (e.g., grid, list, etc.), filtering by supplier, filtering to exclude products that are not on an order guide, etc. In some embodiments, the search results can be provided to the user based on one or more order guides and one or more catalogs loaded into procurement system 202. For example, the purchasing user can be securely authenticated via an API, and an organization and/or facility associated with the purchasing user can be identified in order to load appropriate order guides and/or catalogs of products. Among the different products that show up in the search results, the purchasing user can select products and add different quantities of any of the products to a shopping cart. FIG. 12 shows an example user interface including search results for a second type of product in accordance with some embodiments of the disclosed subject matter. In the example of FIG. 12, the user has entered a search query for “sausage” to search for sausage products.

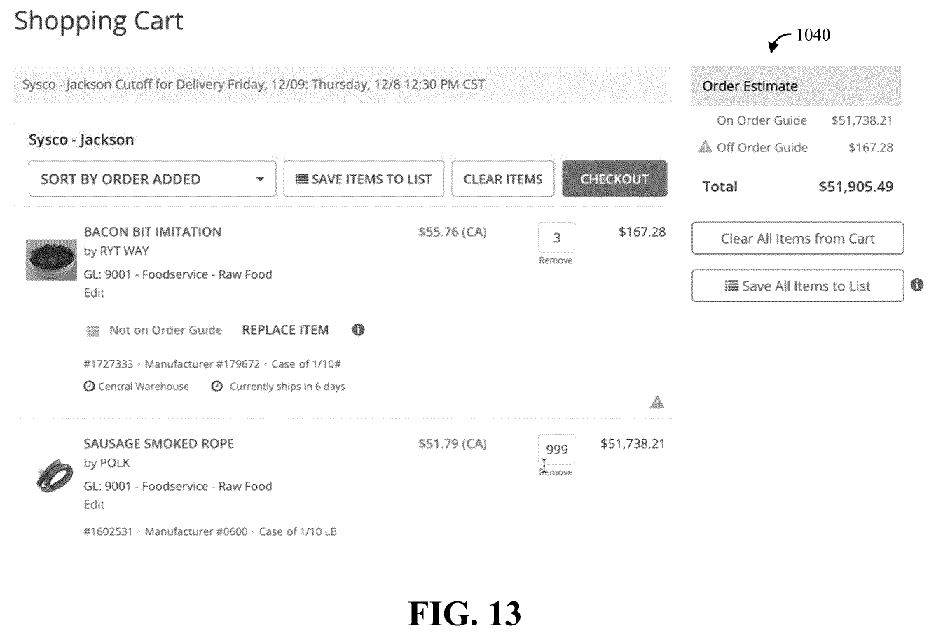

FIG. 13 shows another example shopping cart user interface that can efficiently facilitate product substitutions during procurement in accordance with some embodiments of the disclosed subject matter. The shopping cart page illustrated in FIG. 13 is similar to shopping cart page 1000 as discussed above and can include similar elements as shopping cart page 1000 as shown in FIG. 13. The shopping cart page illustrated in FIG. 13 shows both a bacon bit selected product that the user has added to the shopping cart as well as a smoked sausage rope selected product that the user has added to the shopping cart. In addition, FIG. 13 shows an order estimate 1040 on the shopping cart page that indicates to the user a total cost associated with the selected products in the shopping cart. Order estimate 1040 notably includes separate lines indicating a total cost of products in the shopping cart that are on an order guide and a total cost of products in the shopping cart that arc not on an order guide. The inclusion of order estimate 1040 on the shopping cart page, including the separate lines indicating cost of products on and off order guide, can provide improvements in terms of procurement efficiency for one or more facilities and/or organizations using procurement system 202.

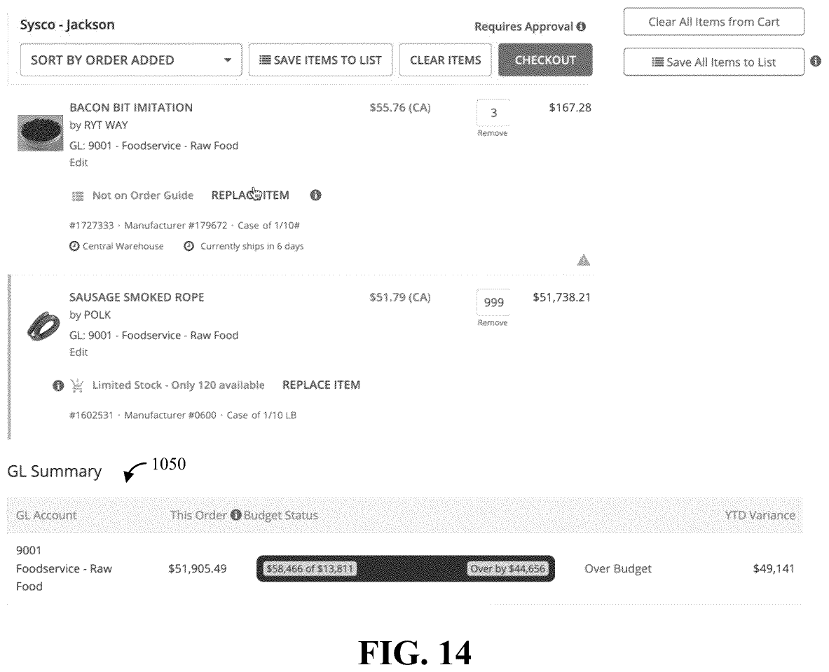

FIG. 14 shows another example shopping cart user interface that can efficiently facilitate product substitutions during procurement in accordance with some embodiments of the disclosed subject matter. The shopping cart page illustrated in FIG. 14 is similar to shopping cart page 1000 as discussed above and can include similar elements as shopping cart page 1000 as shown in FIG. 14. The shopping cart page illustrated in FIG. 14 also includes both the bacon bit selected product that the user has added to the shopping cart as well as the smoked sausage rope selected product that the user has added to the shopping cart as in FIG. 13. Additionally, FIG. 14 shows a budget tracking indicator 1050 that can be presented to the user on the shopping cart page. Budget tracking indicator 1050 indicates the cost of the selected products in the shopping cart relative to a budget. In this particular example, the budget for raw food for a particular facility associated with the user is $13,811 (e.g., an annual budget of $13,811), and the total cost of the products in the shopping cart is $51,905.49. Accordingly, budget tracking indicator 1050 alerts the user (e.g., via various visual user interface elements such as graphics, colors, symbols, etc.) that the order is over budget. It will be appreciated that budget tracking indicator 1050 can be implemented in various ways on shopping cart pages presented to the user.

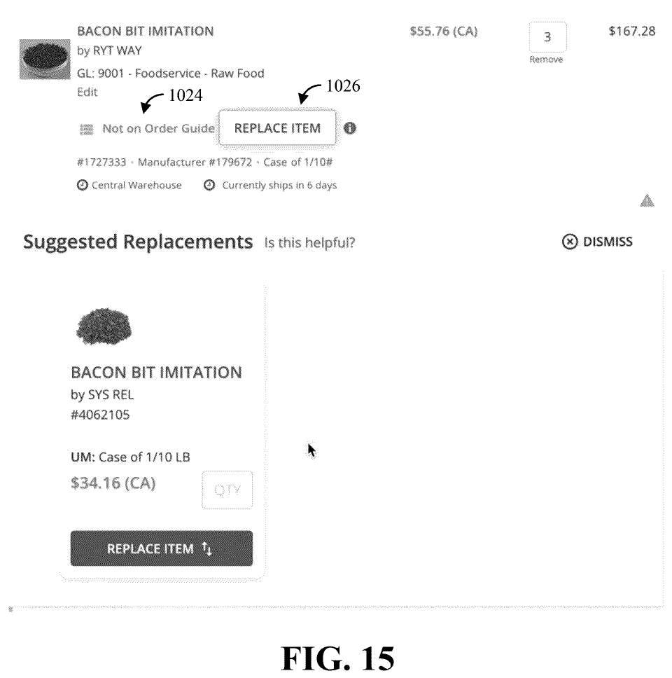

FIG. 15 shows another example shopping cart user interface that can efficiently facilitate product substitutions during procurement in accordance with some embodiments of the disclosed subject matter. The shopping cart page shown in FIG. 15 is similar to shopping cart page 1000 as discussed above and can include similar elements as shopping cart page 1000. The shopping cart page shown in FIG. 15 shows an implementation of warning 1024 whereby warning 1024 indicates that the selected bacon bit imitation product is off order guide. The shopping cart page shown in FIG. 15 also shows another example of replace element 1026, whereby a suggested replacement for the selected bacon bit imitation product is presented via the shopping cart page responsive to the user selecting replace element 1026. In this specific example, the suggested replacement bacon bit imitation product can be substituted for the selected bacon bit imitation product to drive order guide compliance. Although not shown, in some embodiments, the suggested replacement can include a tag (e.g., text, color, icon, etc.) indicating that the product is on order guide (or a corporate recommended substitute), or a supplier recommended substitute. Alternatively, a tag may be presented indicating a particular spend category, or is an on contract item, or is a rebate item. Alternatively, the recommended product may have an indicator that the recommended product is cheaper or has cost savings over the selected product, it may also indicate a percentage or dollar value of savings. Alternatively, the recommended product may have an indicator that the recommended product increases margin over the selected product, and it may also indicate a percentage or dollar value of margin increase.

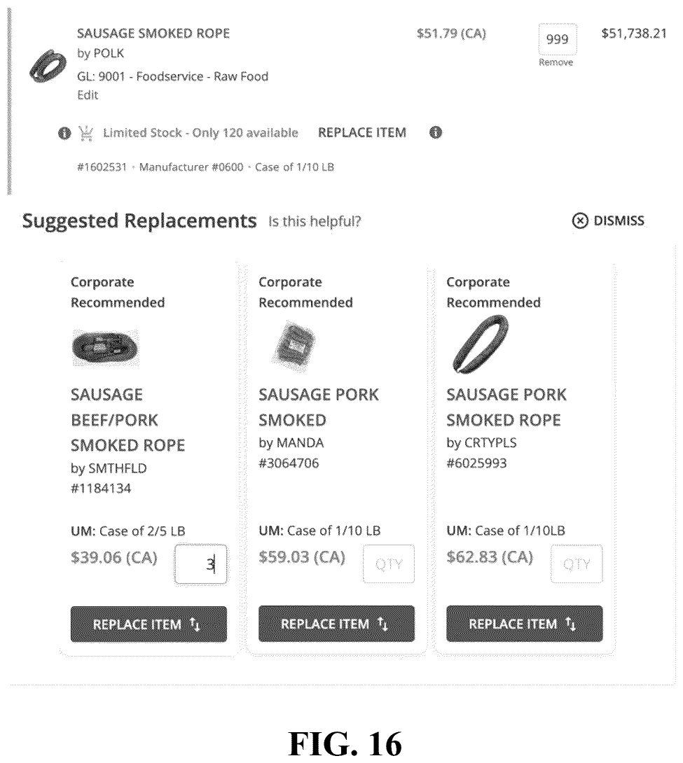

FIG. 16 shows another example shopping cart user interface that can efficiently facilitate product substitutions during procurement in accordance with some embodiments of the disclosed subject matter. The shopping cart page shown in FIG. 16 is similar to shopping cart page 1000 as discussed above and can include similar elements as shopping cart page 1000. The shopping cart page shown in FIG. 16 shows suggested replacements for the selected sausage smoked rope product that can be presented to the user via the shopping cart page. The suggested replacements in this specific example are corporate recommended replacements, such as substitute products generated based on master item backups from a master item grouping from the order guide or order guide management system (e.g., master item groupings 802). However, as noted, substitution evaluations for different selected products can be performed to dynamically identify and present suggested substitute products for replacing selected products in a variety of manners, including using one or more of unsupervised product equivalency learning model 812, supervised product equivalency learning model 814, and feedback graph 816.

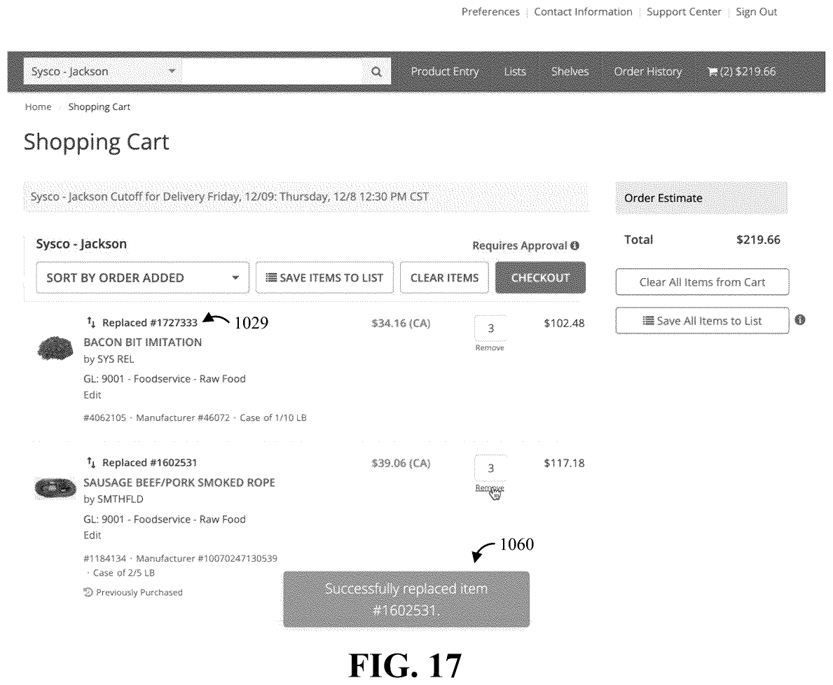

FIG. 17 shows another example shopping cart user interface that can efficiently facilitate product substitutions during procurement in accordance with some embodiments of the disclosed subject matter. The shopping cart page shown in FIG. 17 is similar to shopping cart page 1000 as discussed above and can include similar elements as shopping cart page 1000. The shopping cart page shown in FIG. 17 can be presented responsive to the user swapping out the initially selected bacon bit product and smoked sausage rope product with suggested replacements presented to the user via the shopping cart page. For example, the user can select swap elements such as swap element 1034 and swap element 1038 in order to replace the selected bacon bit product and smoked sausage rope product with substitute products. Upon receiving the selection of the swap elements, as shown in FIG. 17, both a replacement identification 1029 and a replacement indication 1060 can be presented on the shopping cart page. Replacement identification 1029 provides an identifier associated with the substitute bacon bit imitation product that has replaced the initially selected bacon bit imitation product as well as a symbol indicating that the substitute bacon bit imitation product has replaced the initially selected bacon bit imitation product. Replacement indication 1060 can include visual elements (e.g., colors, symbols, etc.) indicating to the user that a successful substitution of the substitute bacon bit imitation product for the initially selected bacon bit imitation product in the shopping cart.

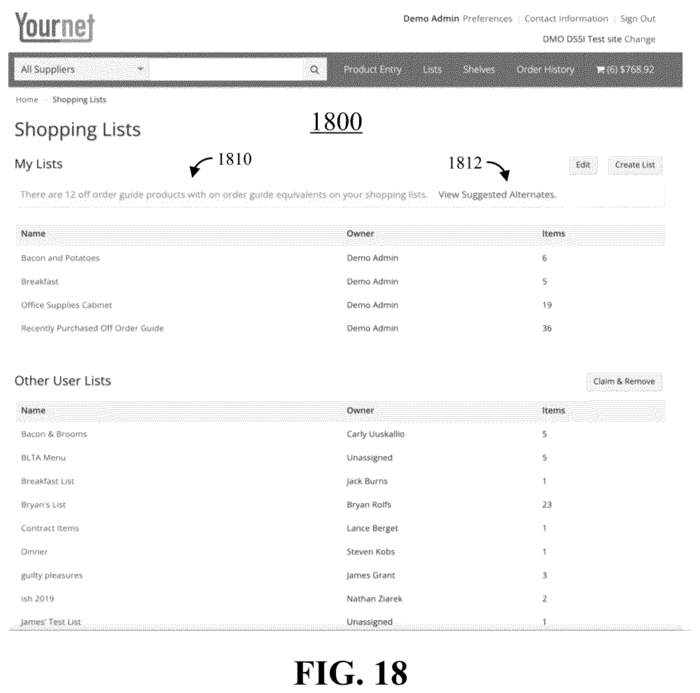

FIG. 18 shows an example shopping list user interface that can efficiently facilitate product substitutions during procurement in accordance with some embodiments of the disclosed subject matter. Specifically, FIG. 18 shows an example shopping list overview page 1800, which includes a variety of different shopping lists (e.g., breakfast, office supplies, etc.) that have been created by the user of procurement system 202 and/or order management system 302, for example. The shopping lists can be stored, and curated lists of products can then be generated based on the shopping lists to facilitate efficient product ordering on a recurring basis. Shopping list overview page 1800 provides another example type of user interface on which substitute product recommendations can be presented to the user in addition to shopping cart page 1000 as detailed above. As shown in FIG. 18, shopping list overview page 1800 includes a substitute notification 1810 indicating to the user that one or more substitute products are recommended for replacing one or more items on one or more of the user's shopping lists. In the specific example shown in FIG. 18, substitute notification 1810 indicates to the user that there are 12 off order guide products with on order guide equivalents on the user's shopping lists. Shopping list overview page 1800 also includes a view substitutes element 1812, which is a selectable user interface element that the user can select to view recommended substitute products associated with substitute notification 1810.

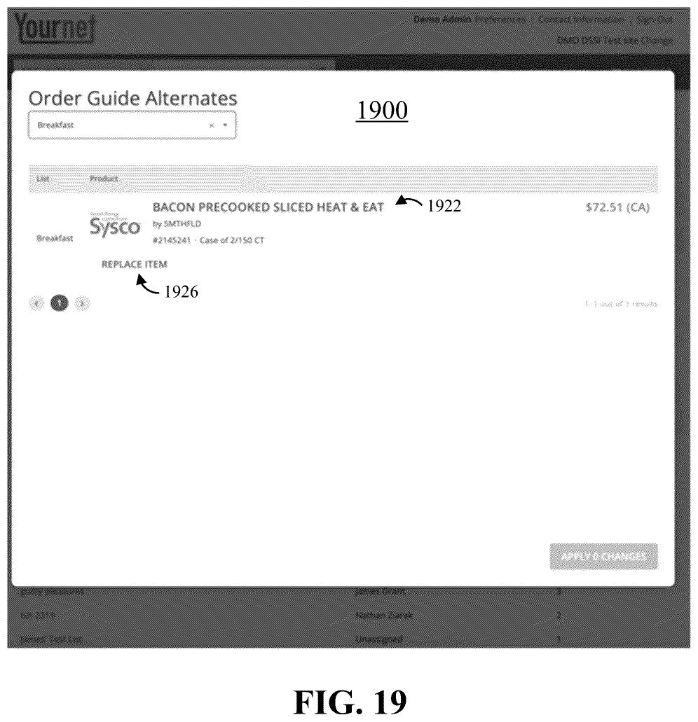

FIG. 19 shows another example shopping list user interface that can efficiently facilitate product substitutions during procurement in accordance with some embodiments of the disclosed subject matter. Specifically, FIG. 19 shows a recommended substitutes window 1900 that can be launched responsive to receiving a selection of view substitutes element 1812, for example. Recommended substitutes window 1900 includes both a substitute product identification 1922 as well as a replace element 1926 associated with substitute product identification 1922. In the example shown in FIG. 19, substitute product identification 1922 identifies a precooked bacon product that is on the user's breakfast shopping list for which there is an alternative product that is on order guide. Replace element 1926 is a selectable user interface element that can be selected by the user to view one or more recommended substitute products that can replace the precooked bacon product on the user's breakfast shopping list.

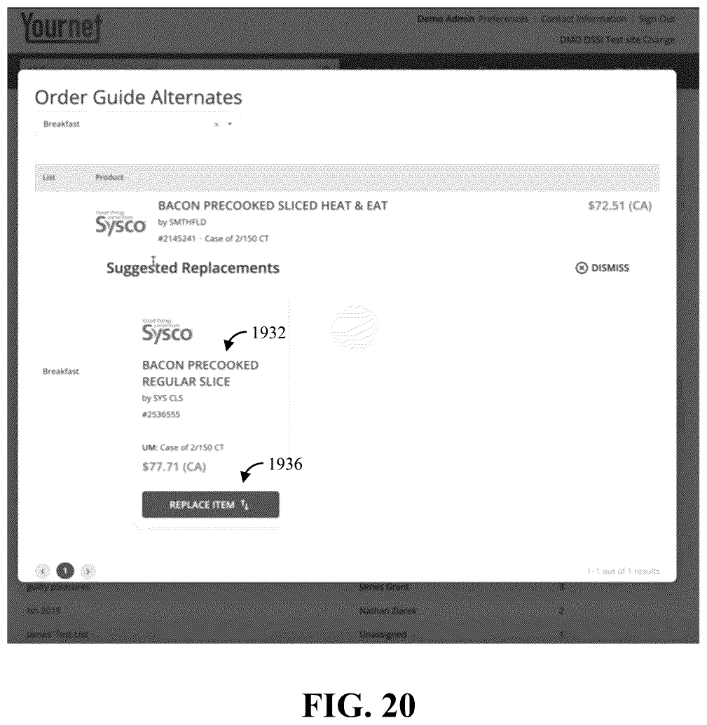

FIG. 20 shows another example shopping list user interface that can efficiently facilitate product substitutions during procurement in accordance with some embodiments of the disclosed subject matter. Specifically, FIG. 20 shows both a substitute product identification 1932 and a swap element 1936 associated with substitute product identification 1932. Both substitute product identification 1932 and swap element 1936 can be presented to the user responsive to receiving a selection of the replace element 1926 presented to the user via recommended substitutes window 1900. In the example shown in FIG. 20, substitute product identification 1932 identifies a different type of precooked bacon product (e.g., associated with different attributes such as a different product identifier, a different quantity, a different distributor, etc.) that is on an order guide associated with the user (e.g., an order guide for a facility or an organization associated with the user). Swap element 1936 is a selectable user interface element that can be selected by the user to initiate a substitution of the suggested on order guide substitute precooked bacon product for the off order guide precooked bacon product.

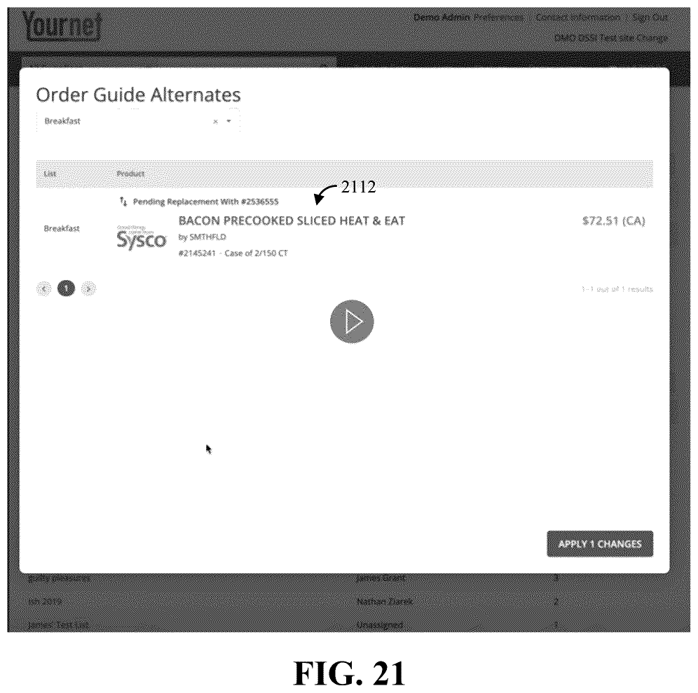

FIG. 21 shows another example shopping list user interface that can efficiently facilitate product substitutions during procurement in accordance with some embodiments of the disclosed subject matter. Specifically, FIG. 21 shows a replacement identification 2112 that can be presented to the user via recommended substitutes window 1900. Replacement identification 2112 indicates to the user that the substitution of the suggested on order guide substitute precooked bacon product for the off order guide precooked bacon product. Replacement identification 2112 can include an identifier associated with the on order guide substitute precooked bacon product and/or other visual user interface elements indicating to the user that the substitution of the suggested on order guide substitute precooked bacon product for the off order guide precooked bacon product has been initiated.

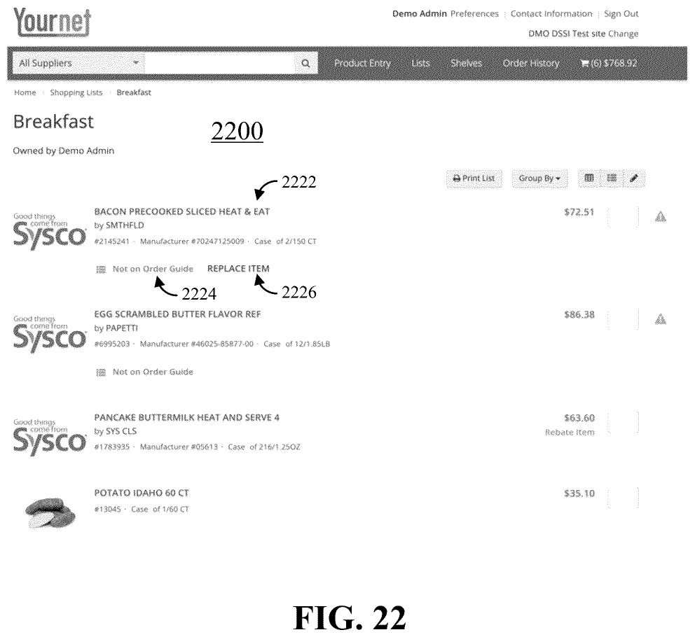

FIG. 22 shows another example shopping list user interface that can efficiently facilitate product substitutions during procurement in accordance with some embodiments of the disclosed subject matter. Specifically, FIG. 22 shows an example shopping list page 2200 showing items on the user's “breakfast” shopping list. Shopping list page 2200 provides yet another example type of user interface on which substitute product recommendations can be presented to the user in addition to shopping cart page 1000 and shopping list overview page 1800 as detailed above. Shopping list page 2200 shows an example of “inline replacements” functionality whereby the user can efficiently view recommended substitute products and replace products on the shopping list with the recommended substitute products. For example, shopping list page 2200 is shown to include a shopping list product identification 2222, a warning 2224 associated with shopping list product identification 2222, and a replace element 2226 associated with shopping list product identification 2222.

Shopping list product identification 2222 as shown in FIG. 22 identifies a precooked bacon product that is on the user's breakfast shopping list. Warning 2224 indicates to the user that the precooked bacon product that is on the user's breakfast shopping list is not on an order guide associated with the user (e.g., an order guide for a facility or an organization associated with the user). Warning 2224 can be implemented in a variety of ways, including using a specific text, color, icon, image, etc. or combination thereof, used to convey a specific message. Replace element 2226 is a selectable user interface element that can be selected by the user to view one or more recommended substitute products that can replace the precooked bacon product on the user's breakfast shopping list.

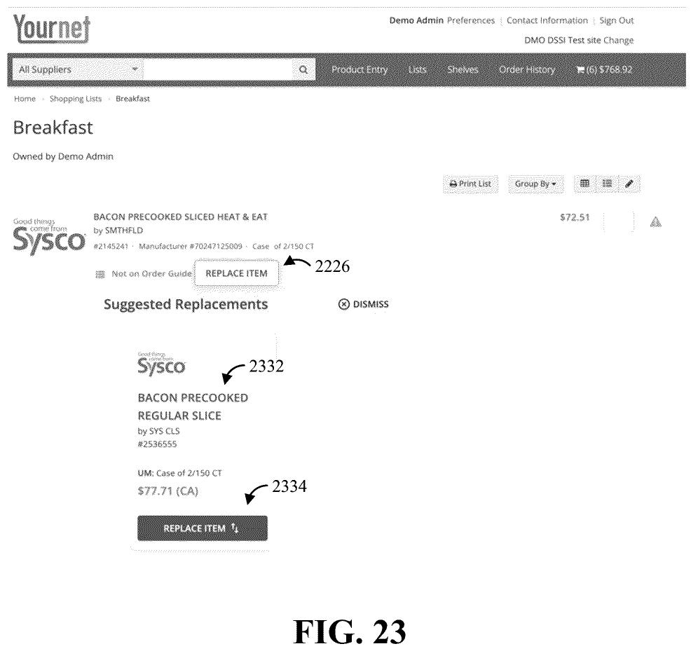

FIG. 23 shows another example shopping list user interface that can efficiently facilitate product substitutions during procurement in accordance with some embodiments of the disclosed subject matter. Specifically, FIG. 23 shows an example inline substitute product recommendation that can be presented to the user responsive to receiving a selection of replace element 2226 from the user via shopping list page 2200. As shown, the inline substitute product recommendation includes both a substitute product identification 2332 and a swap element 2334 associated with substitute product identification 2332. In the example shown in FIG. 23, substitute product identification 2332 identifies a different type of precooked bacon product that is on an order guide associated with the user. Swap element 2334 is a selectable user interface element that can be selected by the user to initiate a substitution of the suggested on order guide substitute precooked bacon product for the off order guide precooked bacon product. Responsive to receiving a selection of swap element 2334, a substitution of the suggested on order guide substitute precooked bacon product for the off order guide precooked bacon product can be initiated, and a notification or identification similar to replacement identification 2112 can be presented to the user to indicate that the user has initiated the substitution of the suggested on order guide substitute precooked bacon product for the off order guide precooked bacon product.

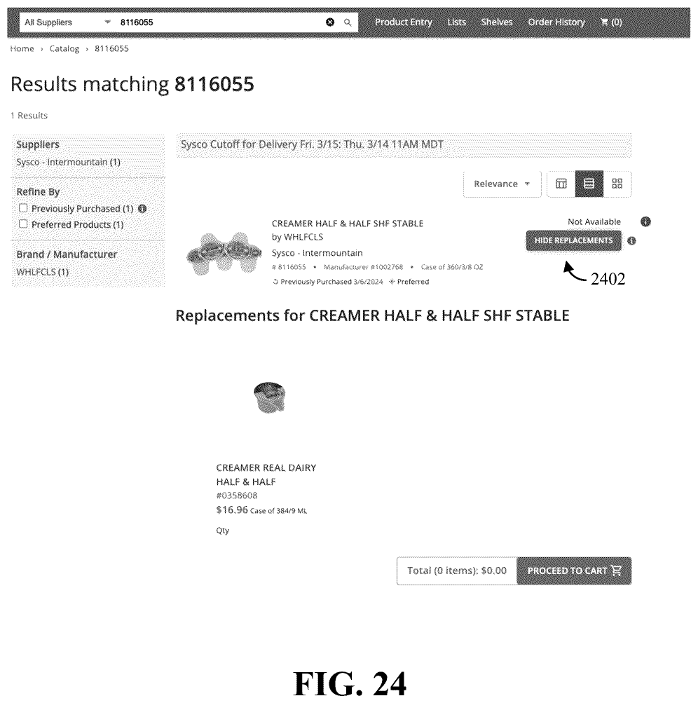

FIG. 24 shows an example product search user interface that can efficiently facilitate product substitutions during procurement, in accordance with some embodiments of the disclosed subject matter. Specifically, FIG. 24 shows an example type of user interface through which substitute product recommendations can be presented to the user while searching for products. In particular, substitute recommendations can be presented to the user if the user searches for an inactive or discontinued product. The product search user interface can display an indicator that the product is “Not Available” for example and also display a user interface element (e.g., a show/hide replacements button 2402) for displaying substitute product recommendations when selected. It can also show substitute product recommendations based on other reasons including the searched product being out of stock or limited stock with the supplier, the searched product being off order guide, etc. Specifically, in FIG. 24, the user has entered a search query for a particular product identifier associated with a half and half creamer product. However, the half and half creamer product is not available because it has been discontinued (e.g., it is no longer in production), so the product search user interface presents an indicator showing the user that the half and half creamer product is not available and also show/hide replacements button 2402 on the product search results page itself. Upon selection of the show/hide replacements button 2402 by the user, the product search user interface presents a replacement type of half and half creamer product that the user can add to the cart from the same product search results page.

As another example, a shelves user interface can be implemented to efficiently facilitate product substitutions during procurement, in accordance with some embodiments of the disclosed subject matter. The shelves user interface can be similar to the example shopping list user interfaces detailed above in that it can include products that are commonly ordered for a facility, but it can also include placement of the item (e.g., location of the item in inventory, such as top shelf, middle shelf, bottom shelf, or labeled location). Each item can also have an associated corresponding periodic automatic replacement (PAR) level (e.g., a quantity of the item that should be in stock when to meet demand when reordering). Each item can include an actual quantity on hand in inventory. The shelves user interface can present substitute product recommendations, for example for order guide compliance (e.g., one or more substitute product recommendations on the order guide can be shown for an item that is not on an order guide). The shelves user interface can also include out of stock replacement product recommendations when an item is added to the cart from the shelves, for example.

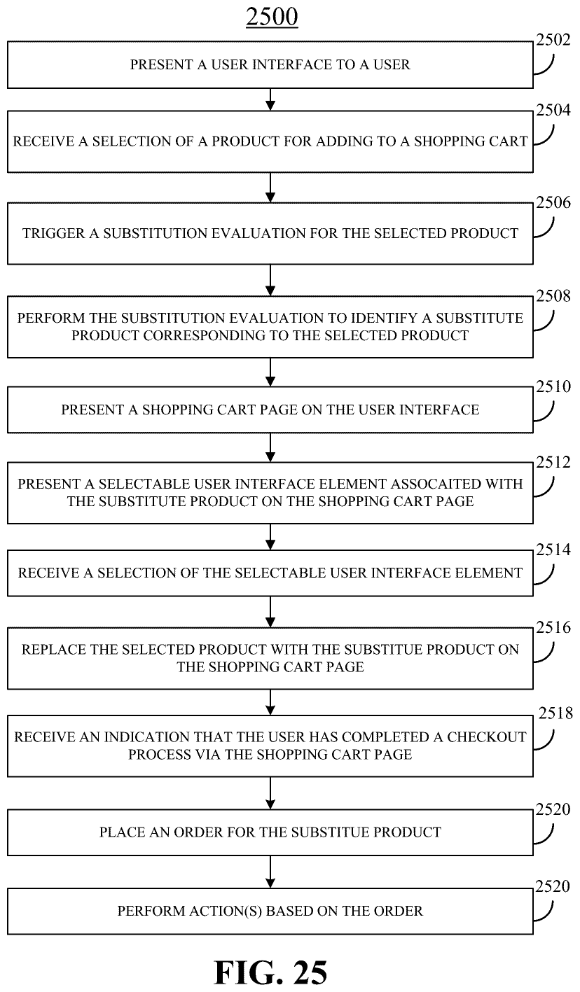

FIG. 25 shows a flowchart of an example process 2500 for optimizing ordering events within a procurement system, in accordance with some embodiments of the disclosed subject matter. Process 2500 can be performed using one or more different systems, such as procurement system 202 and/or order management system 302. Process 2500 can provide different types of purchasing users and other types of users with automatic optimization of ordering events to drive various efficiencies and to help different types of organizations meet various goals. Process 2500 generally involves triggering and providing substitute product recommendations and presenting substitute products via a specifically structured user interface that allows for efficient automatic optimization of ordering events. For example, process 2500 can be used to drive various outcomes, including order guide compliance, order guide management (e.g., creating and editing order guides), spend management, and margin/spending optimization, among other possible outcomes. Notably, the presentation of substitute product recommendations and swapping of substitute products for selected products that occurs via process 2500 can be implemented without making any changes to any order guides that may be used for a given facility or organization.

At 2502, process 2500 can present a user interface to a user via a user device. For example, procurement system 202 can present a procurement user interface to a purchasing user that allows the purchasing user to search for different items and to select different items for adding to a shopping cart, such as the user interfaces shown for example in FIG. 11 and FIG. 12 as discussed above. In some embodiments, data used to present the user interface can be provided to procurement system 202 by one or more distinct systems (e.g., order management system 302, etc.). For example, order management system 302 can provide one or more order guides and/or one or more catalogs to procurement system 202, and procurement system 202 can then populate a template or similar type of data structure using the one or more order guides and/or one or more catalogs such that the user interface presented to the user is based on the one or more order guides and/or one or more catalogs provided by order management system 302. Data used to present the user interface can also be managed within procurement system 202 itself in some embodiments. The user device can be implemented in a variety of manners, including as a laptop, a desktop computer, a tablet, a smartphone, etc.

At 2504, process 2500 can receive a selection of a product for adding to a shopping cart based on a first interaction between the user and the user interface. For example, procurement system 202 can receive a selection of a food product or another type of product from the purchasing user based on an interaction between the purchasing user and the user interface. The purchasing user may search for different items (e.g., bacon imitation, sausage, bananas), enter quantities associated with items that show up in the search results, and then add the selected quantity of the selected items to a shopping cart by selecting a selectable user interface element. For example, the purchasing user can select 100 cases of fresh green tip bananas via the user interface, and the selection of the 100 cases of fresh green tip bananas can be received by procurement system 202.

At 2506, process 2500 can trigger a substitution evaluation for the selected product. For example, after receiving the selection of the 100 cases of fresh green tip bananas from the purchasing user via the user interface, procurement system 202 can trigger a substitution evaluation regarding the 100 cases of fresh green tip bananas. In some embodiments, the substitution evaluation can be triggered by and/or be performed by order management system 302 or another similar type of system. For example, procurement system 202 can communicate with order management system 302 to indicate that the 100 cases of fresh green tip bananas have been selected by the user, and then order management system 302 can evaluate the selection of the 100 cases of fresh green tip bananas relative to one or more triggers. Procurement system 202 can also perform the triggering of the substitution evaluation for the 100 cases of fresh green tip bananas itself. A variety of different types of triggers can be implemented, as detailed below.

A stockout trigger can be implemented such that substitutions evaluations are triggered responsive to determining that not enough of a selected product is in stock. For example, if a distributor associated with the fresh green tip bananas only has 62 cases of the selected fresh green tip bananas in stock, then the stockout trigger can be activated for the user selection of the fresh green tip bananas. Procurement system 202 and/or order management system 302 can query distributor databases (e.g., database 412) in order to evaluate the real-time availability of selected products. As another example, if the user selects one case of smoked sausage rope, but a distributor associated with the selected smoked sausage rope has zero cases of the smoked sausage rope currently available for distribution, then the stockout trigger for the user selection of the smoked sausage rope can be activated.

An order guide compliance trigger can also be implemented in various manners to help drive order guide compliance and achieve various goals. For example, if the 100 cases of green tip bananas selected by the purchasing user are not on an order guide (e.g., associated with the same facility or the same organization as the purchasing user), then the order guide compliance trigger can be activated. In some embodiments, users of procurement system 202 may use procurement system 202 in a “locked down” configuration such that products not on an order guide are hidden and possibly allowed to be viewed as secondary options. In such configurations, triggers such as the stockout trigger can provide a way for a facility to order a substitute product that is not on the order guide in a “pinch” by relaxing order guide controls when preferred products are at least temporarily unavailable.

Various types of financial-related triggers can also be implemented to help achieve various financial goals and/or comply with different requirements. For example, some users can be part of not-for-profit organizations that rely on government grants for funding. To qualify for these grants, the organization may be required to meet certain spending goals, such as minimum spending on products distributed by women-owned, or minority-owned business enterprises (WMBE). However, previous approaches to determining appropriate products to purchase from WMBE vendors and other similar types of vendors can be highly complex. Products from vendors such as WMBE vendor can have limited availability and/or be significantly more expensive than alternatives. Also, the process of manually sorting through thousands of smaller vendors to determine whether they qualify for WMBE status can be so time-intensive that it is prohibitive.

Other types of financial-related triggers, such as cost savings and margin optimization triggers can be implemented. Even if a selected product is on a relevant order guide, another potential, more cost-effective option could be available that may not be on the relevant order guide. A substitution evaluation can be triggered responsive to determining that a more cost-effective option is included on the relevant order guide. The realized cost savings by switching to a substitute can then be tracked and the realized cost savings data can be used to drive order guide actions. For example, if the cost savings that can be realized by substituting one product for another on an order guide meets a certain threshold, the substitutions can be implemented on the order guide to drive future cost savings. This order guide change can be done automatically when an order is placed, and an evaluation is done. Alternatively, a notification can be triggered to a corporate user to be presented with information including the selected product, the substitute product, the cost savings, etc. The corporate user can then manually make or approve the change. Similarly, a substitution evaluation can be triggered responsive to determining that a potential substitute product has greater margin than the selected product. The increased margin associated with the substitute product can likewise be tracked and used to drive order guide actions.

Moreover, triggers related to spend tracking against inputted budgets and minimum spend can also be implemented. Transaction data across an organization (e.g., for multiple facilities associated with the same organization) can be aggregated to provide insight on spend tracking. For example, when a facility places an order (or adds products to a shopping cart) that will go over a specific budget (could be based on actual or projected spending), one or multiple recommendations can be made. A budget tracking indicator (e.g., budget tracking indicator 1050) can be presented to the user via the user interface on the shopping cart page indicating the cost of one or more items currently in a shopping cart relative to a budget. If the cost of the one or more items exceeds the budget, a trigger can be activated to generate substitute recommendations for the one or more items in the shopping cart. The substitute recommendations can include cheaper alternatives with the same unit of measure (UOM) or with lesser UOM, for example. Cheaper alternatives can include substitution of a group of ingredients for a single product in some cases, for example substituting ingredients used to make lasagna for pre-made lasagna (and vice versa). Also, recommendations to perform actions including removing a product from the order (shopping cart), reducing the quantity of a product for the order, or moving a product for the order to a later date (i.e., a future order), for example, that are not necessarily substitution recommendation can also be provided to the user via the user interface in order to facilitate compliance with spend tracking goals.

Aggregate transaction data can be used to track spending for purposes including tracking against minimum levels for grants, subsidies, contract tiers, U.S. Securities and Exchange Commission (SEC) rules (e.g., environmental, social, and corporate governance (ESG) tracking and reporting for publicly traded companies), rebates, and/or other incentives. Substitute optimization can be performed to minimize the additional spend (e.g., SKU to SKU) on qualifying substitutes (e.g., qualified products from WMBE vendors) required to meet minimum spend levels for these categories, thereby reducing overall cost. For example, efficiently selecting only substitute products that count towards certain spending categories that are the least increase in price from their non-qualifying cheaper substitutes can be facilitated. Moreover, the tracked spend can be used to drive order guide actions once minimum (threshold) levels are met. For example, recommendations to change (or automatically changing actively) the order guide to reduce surplus spending on qualifying products once minimum levels have been met can be implemented.

In some cases, the available quantity of a substitute product may be limited such that only a portion of a selected quantity of a product can be replaced with the available quantity of substitute product. In such cases, a substitute recommendation can still be provided to the user via the user interface to swap just a portion of the selected product with the available quantity of the substitute product to help the facility and/or organization stay on track to meet spending goals. The prioritization of qualifying substitute products can be increased or decreased as needed to keep the organization and/or facility on track to meet spending goals.

Facility census data can also be used to trigger substitute recommendations. For example, a given facility, such as a senior living facility, may previously have had 100 residents, but now has only 70 residents. Accordingly, an order guide associated with the facility may be configured based on the population of 100 residents. Also, a purchasing user may not be aware that the population of the facility has changed since the last time the purchasing user placed an order for the facility. In such cases, the quantity of one or more selected items can trigger a substitutions evaluation based on changed facility census data. Previous order history can also be used to trigger substitution evaluations based on facility census data. The substitution recommendation, in such examples, can then recommend to the user that a quantity associated with one or more selected items should be reduced based on the facility census data (or increased in the case of the population of residents increasing). The facility census data may be data entered by the organization. Alternatively, it may be based on a connection with another system (e.g., an electronic medical record (EMR) system). In some cases, other data from a connected third-party system (e.g., an EMR system), such as data specific to particular residents of a facility (e.g., medical information, nutritional requirements, etc.) can be used to trigger substitute recommendations, or additions to an order. This can be accomplished through a systematic connection between the systems via an API integration.

Triggers related to approval history can also be implemented. Approval history data across an organization (e.g., for multiple facilities associated with the same organization) can be aggregated. For example, when a facility places an order (or adds products to a shopping cart) that includes an item that has been previously rejected (e.g., multiple times over a predefined threshold) by a second user (e.g., approver), one or multiple recommendations can be made. For example, recommendations can be displayed to the purchasing user to change the order by removing the product or replacing the product with a recommended substitute product. The recommendation can also include displaying a message to the purchasing user indicating that the product has previously been rejected by the approval user. The aggregate approval history can also be used to make recommendations to change the order guide. For example, if an off-order guide product is repeatedly approved, a recommendation can be generated and provided within the order guide management system to add the product to the order guide. The recommendation can be in the form of a notification or alert to a corporate user within an order guide management user interface where the user can make the order guide change accordingly, for example. Alternatively, the addition of the product to the order guide can be done automatically if certain conditions are met.

Facility inventory data can also be used to trigger product recommendation evaluation. For example, facility inventory data can be received from a facility inventory system. The facility inventory data can include a quantity of an item in inventory at a facility. The quantity of the item at the facility can be compared with a minimum quantity threshold (e.g., PAR level) for restocking that item. If the quantity of the item at the facility is below the minimum quantity threshold, then the trigger can cause a recommendation to be presented to the user to order the item. As an example, the trigger can cause a recommendation to be presented within a shelves user interface such as discussed above to facilitate the purchasing of products. Similar to the shopping lists user interface, the shelves user interface allows for creating a list of items that are repeatedly purchased but also tracking a corresponding placement of each item within inventory to facilitate efficiently taking inventory. The recommendation to add a product to an order can also be presented to a user while the user is taking inventory, and the trigger can be activated based on an update to the inventory as input by the user. The recommendation can be the same item, or a substitute item based on other evaluations (e.g., supplier inventory).

Triggers related to a product being marked as being inactive can also be implemented. For example, a product that is presented in a product search user interface based on a user search for a particular product in a procurement system can trigger a substitute product evaluation if the product is marked as an inactive product (e.g., the product is no longer available for purchase). As discussed for various shopping cart user interfaces, the product search user interface can include a selectable user interface clement associated with an active substitute product that is selectable by the user for adding the substitute product to the shopping cart. For an inactive product, a similar type of substitute product recommendation can occur within the shopping lists user interface or shelves user interface, if the user selects a selectable user interface element to swap the inactive product with a substitute, a persistent change to the shopping list or shelf list can be made.

Triggers related to supplier information including supplier/distributor inventory levels, product expiration information, replenishment rates, forecasting models, supplier product expiration information, information related to time product has been in inventory, and/or customer order guide selections can also be implemented. As one example, if a product is selected, equivalent products can be determined, and an equivalent product can be recommended based on a trigger related to expiration information of the equivalent product in order to move the equivalent product and reduce spoilage. This can also trigger a price reduction and corresponding message to incentivize switching to the equivalent product. This trigger can be based on supplier information, including product expiration information, time the equivalent product has been in inventory, and/or other information for the equivalent product. As another example, an equivalent product can be recommended away from default selections to prevent stockouts. This functionality can allow a supplier to adjust inventory levels for a selected product to account for projected demand, which can in part be based on forecasted demand and/or recent order guide changes (e.g., a signal indicating the increased demand can be sent to the supplier). As an alternative example, an equivalent product can be recommended away from default selections to benefit supplier stocking situations, such as, for example, clearing stagnant stock (e.g., to reduce spoilage by integrating supplier information regarding product expiration dates). This type of functionality can also include the particular supplier for the product and corporate supplier preferences. As an example, based on a supplier for a selected product, an equivalent product from another supplier can be recommended. As another example, an equivalent product can be recommended that supports incentives for the customer (e.g., supplier drop size, brand incentives, etc.).

Triggers related to other supplier information such as, for example, the delivery date of products can also be implemented. As one example, if a product is selected and has a delivery date and time after a predetermined desired delivery date, one or more equivalent products can be determined, and an equivalent product can then be recommended based on a delivery date being before the predetermined desired delivery date. The predetermined desired delivery date can be set by a user for a particular order or can be a default delivery date based on an expected delivery time (e.g., 7 days, etc.). The expected delivery date information of products can be received from or determined from information received from supplier or distributor systems such as discussed above, for example.

At 2508, process 2500 can perform the substitution evaluation to identify a substitute product corresponding to the selected product. The substitution evaluation can be performed using one or more of unsupervised product equivalency learning model 812, supervised product equivalency learning model 814, feedback graph 816, and supplier recommendations 818, for example, as discussed above. The substitution evaluation can also be performed by evaluating an order guide, and identifying at least one acceptable alternative item as defined by the order guide. The dynamic performance of the substitution evaluation in this manner to identify the substitute product corresponding to the selected product can provide improved efficiency for the purchasing user, the facility and/or the organization associated with the purchasing user, as well as for the distributors associated with procurement system 202. The substitution evaluation can leverage aggregate data from a variety of different order transactions, for example by updating order guides and training artificial intelligence models as detailed above. Accordingly, performance of the substitution evaluation can identify the substitute product corresponding to the selected product as being likely to be viewed favorably by the particular purchasing user, and thereby likely to facilitate technical efficiencies in the procurement process.

At 2510, process 2500 can present a shopping cart page on the user interface. For example, shopping cart page 1000 or another similar shopping cart page can be presented on the user interface. The shopping cart page can include both an identification of the selected product as being in the shopping cart for purchasing (e.g., selected product identification 1022) and an identification of the substitute product as being suggested for replacing the selected product in the shopping cart (e.g., substitute product identification 1032). The shopping cart page can advantageously present suggested substitute items (e.g., suggest replacements 1030) in close proximity below the identification of the selected product. The suggested substitute items can be presented in response to receiving a selection of a user interface element such as replace element 1026. The suggested substitute items can be presented without selection of a user interface element such as replace element 1026, and instead can be automatically presented in response to the triggering of the substitution evaluation.

At 2512, process 2500 can present a selectable user interface element associated with the substitute product on the shopping cart page. For example, process 2500 can present swap element 1034 on shopping cart page 1000. The selectable user interface element associated with the substitute product can be presented with various visual elements (e.g., colors, symbols, etc.) to draw the attention of the user to the selectable user interface element. The selectable user interface element provides an efficient way for the user to perform a substitution within the shopping cart page itself based on a dynamic recommendation for a substitute item identified based on the substitution evaluation. The user simply needs to select (e.g., click, tap, touch, etc.) the selectable user interface element in order to perform the substitution and replace the selected product with the recommended substitute product. As discussed above, similar types of selectable user interface elements can also be provided on a product search results user interface, a shopping list page user interface, a shelves user interface, and/or various other types of user interface.

At 2514, process 2500 can receive a selection of the selectable user interface element from the user based on a second interaction between the user and the user interface. For example, the user may touch, tap, click, or otherwise select swap element 1034 on shopping cart page 1000. At 2516, process 2500 can replace the selected product in the shopping cart with the substitute product responsive to receiving the selection of the selectable user interface element from the user based on the second interaction between the user and the user interface. For example, process 2500 can replace selected bacon bit imitation product with a suggested substitute bacon imitation product in the shopping cart. Process 2500 can also present indicators on the user interface such as replacement identification 1029 and replacement indication 1060 on the user interface via the shopping cart page.

At 2518, process 2500 can receive an indication that the user has completed a checkout process to purchase the substitute product in the shopping cart. At 2420, process 2500 can generate and place an order for the substitute product with a distributor associated with the substitute product responsive to receiving the indication the user has completed the checkout process to purchase the substitute product in the shopping cart.

At 2522, process 2500 can perform one or more actions based on the order. For example, based on data associated with the order, process 2500 can infer a reason for replacing the selected product with the substitute product. Based on the reason, a purchase order for the substitute product can either be automatically generated and approved, or the purchase order along with information (e.g., the inferred reason for replacing the selected product, such as a stockout or limited stock situation) can be provided to a second user distinct from the purchasing user that placed the order for approval. In some cases, if a purchase order requires approval by the second user, process 2500 may not place the order until it receives an approval of the purchase order from the second user. The approval of the purchase order may be based on an input received from the second user via a separate computing device. Approvals may be required for various reasons, for example, if there are off order guide products in the order, the total cost of the order would go over budget (or projected to go over budget), the order includes products or quantities of products not typically ordered (e.g., for a particular facility, purchaser, number of residents, etc.), or based on other configurations for generating approvals. Other examples that can trigger an approval requirement include job type of the user, the general ledger (GL) code assigned to the order, whether or not the order is considered a capital expenditure, the supplier(s) involved, or any combination of the potential triggers.

The order information including the products ordered, and corresponding quantity and cost of the products, among other information (e.g., spend category) can then be aggregated with order history for the facility and/or across multiple facilities for an organization. This aggregated information can be used to trigger order guide actions, for example, when a particular spend category has reached a particular threshold in order to meet a minimum spend requirement for a predetermined period of time to maximize savings. The order guide actions may be triggered automatically or be a notification to a user to make a manual change to the order guide. Furthermore, a change to an order guide may dynamically change what products are recommended as substitutes from one order to the next. As an illustrative example, in a first order a first product may be recommended as a substitute product for a selected second product based on needing to reach a predetermined minimum spend requirement in a particular spend category even despite the first substitute product being a higher cost than the selected second product. Once the predetermined minimum spend requirement in the particular spend category is reached, an order guide action may be triggered, for example, to replace the first product with a second product in the order guide based on the second product being cheaper (or having more margin). Alternatively, the second product may be simply prioritized over the first product based on the second product being cheaper or having more margin than the first product and the minimum spend requirement being met that previously prioritized the first product over the second product. Prioritization may be done to minimize overall spending. Then, in a second order at a later time than the first order, the first product may be a selected product and the second product may be recommended as a substitute product.

Moreover, at 2522, various other types of actions can be performed based on the order, including driving order guide actions, providing feedback to learning models such as models 812 and 814, updating prioritization rules used to aggregate and prioritize substitute products used in substitute product recommendations, and other types of actions as detailed above. The aggregation of large amounts of data related to a variety of different types of substitution recommendations, user feedback and responses to substitute recommendations, and other data associated with ordering actions can be used to provide more dynamic product substitution recommendation functionality for future ordering events that occur within procurement system 202 and/or order management system 302.

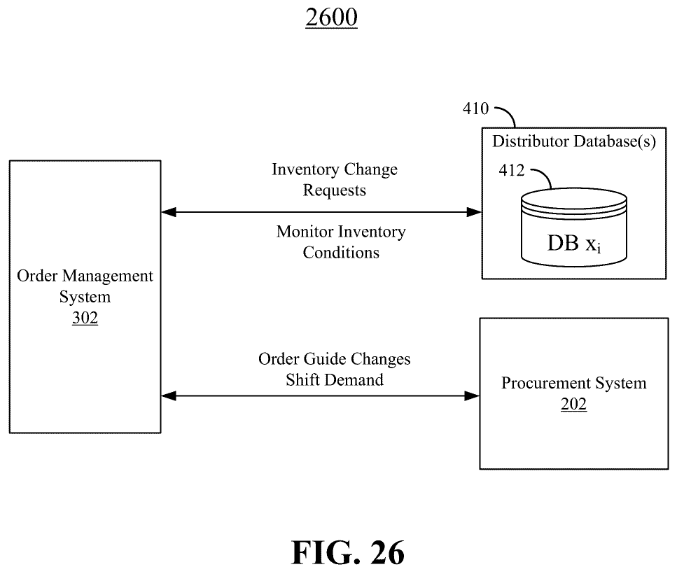

FIG. 26 shows an example system 2600 for coordinating product inventory with order guide changes in accordance with some embodiments of the disclosed subject matter. The system 2600 is shown to include order management system 302, procurement system 202, and distributor database server 410. To get the best value products and adapt to changing business needs (e.g., seasonal food menus, dynamic healthcare patient needs, etc.), purchasing organizations (e.g., facilities) often make changes to the order guides they use to place orders for products with distributors. The order guide changes cause immediate shifts in purchasing demand for distributors who already have inventory on hand to meet prior demand levels. In some previous and existing approaches, collaboration between organizations and distributors for demand changes is either non-existent or manual, takes too long (e.g., 30-45 days), and still is not fully precise in nature. System 2600, however, can be used to address these and other shortcomings by providing more dynamic collaboration between different organizations and distributors regarding demand changes resulting from order guide changes.

As shown in FIG. 26, order management system 302 can connect directly with distributor logistics systems (e.g., via distributor database server 410) to automatically coordinate changes in demand. In system 2600, order management system 302 can initiate and manage order guide changes of various types (e.g., switching from Product A to Product B, and others). Based on the managed order guide changes, order management system 302 can send inventory change requests (e.g., demand signals) to distributor database server 410 and monitor inventory conditions by communicating with distributor database server 410. The distributor logistics systems can then receive the requests to alter inventory (e.g., the demand signals) and initiate inventory changes. In certain scenarios, some level of manual oversight may be required within the distributor logistics systems before inventory changes are initiated. As detailed above, distributors can have a variety of regional distribution centers for which inventory needs to be managed. Order management system 302 can communicate with procurement system 202 (e.g., an eCommerce purchasing platform) to coordinate shifting demand resulting from order guide changes.

In general, order management system 302 can stage order guide changes such that the order guide changes remain pending and are not implemented (order guide remains unchanged) until one or more inventory conditions have been met. For example, in response to receiving an order guide change from a user, order management system 302 can calculate a projected product usage associated with the order guide change (e.g., Product B will be used X amount over Y time). In some cases, order management system 302 can also receive product usage data as input. Then, order management system 302 can send one or more demand signals to one or more appropriate distributor logistics systems automatically based on the determined product usage. Finally, once order management system 302 determines that the distributor has sufficient inventory of the product, order management system 302 can implement the order guide change.

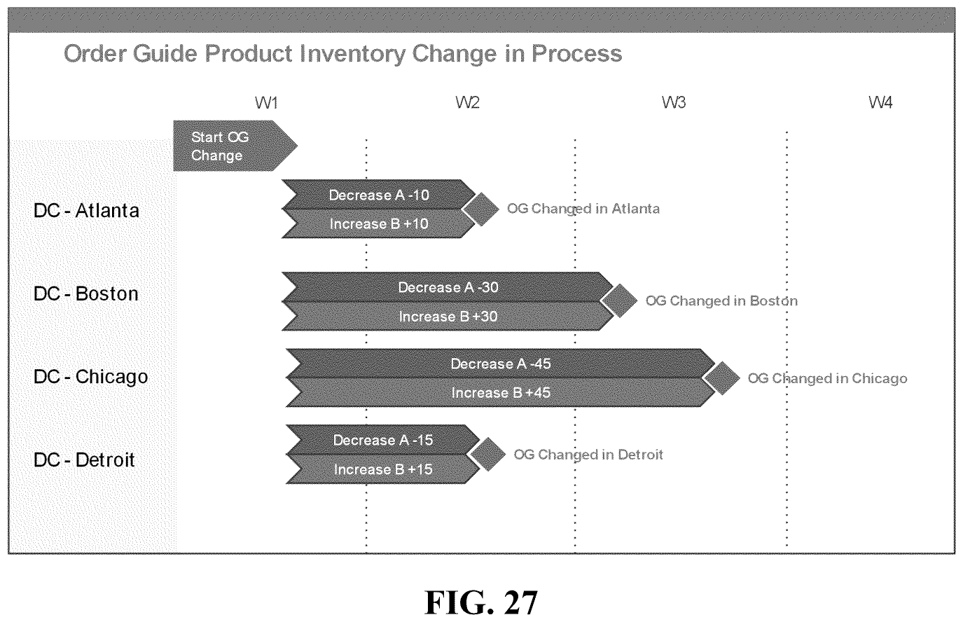

FIG. 27 shows a graphical illustration of an example order guide product inventory change process that can be implemented using system 2600, in accordance with some embodiments of the disclosed subject matter. In the example shown, Product A (e.g., a first type of chicken food product) is replaced with Product B (e.g., a second type of chicken food product) on an order guide. Product A is provided by a first manufacturer, whereas Product B is provided by a second manufacturer. Before the order guide change, an organization (e.g., a facility or multiple facilities) associated with the order guide change was purchasing 100 cases per week of Product A from 4 different regional distributions centers located in the cities of Atlanta, Boston, Chicago, and Detroit. In the graphical illustration shown in FIG. 27 the order guide change is received by order management system 302 (e.g., based on a user input) during a first week (W1).

After receiving the order guide change, order management system 302 determines changes in product usage for each of the 4 different regional distributions centers located in the cities of Atlanta, Boston, Chicago, and Detroit. As shown, for Atlanta, the order guide change will result in a decrease of 10 cases of Product A per week and an increase of 10 cases of Product B per week. For Boston, the order guide change will result in a decrease of 30 cases of Product A per week and an increase of 30 cases of Product B per week. For Chicago, the order guide change will result in a decrease of 45 cases of Product A per week and an increase of 45 cases of Product B per week. For Detroit, the order guide change will result in a decrease of 15 cases of Product A per week and an increase of 15 cases of Product B per week.

As shown in FIG. 27, the staging of the order guide change takes different amounts of time for each of the regional distribution centers. In Atlanta, order management system 302 determines that the change in inventory (e.g., increase of 10 cases of Product B per week) has been completed in about one week. Then, order management system 302 implements the order guide change such that the organization uses the order guide to order 10 cases of Product B per week from the Atlanta distribution center instead of 10 cases of Product A per week from the Atlanta distribution center. In Detroit, order management system 302 determines that the change in inventory (e.g., increase of 15 cases of Product B per week) likewise has been completed in about one week. Then, order management system 302 implements the order guide change such that the organization uses the order guide to order 15 cases of Product B per week from the Detroit distribution center instead of 15 cases of Product A per week from the Detroit distribution center.

In Boston, order management system 302 determines that the change in inventory (e.g., increase of 30 cases of Product B per week) has been completed in just under two weeks. Then, order management system 302 implements the order guide change such that the organization uses the order guide to order 30 cases of Product B per week from the Boston distribution center instead of 30 cases of Product A per week from the Boston distribution center. In Chicago, order management system 302 determines that the change in inventory (e.g., increase of 45 cases of Product B per week) has been completed in just over two weeks. Then, order management system 302 implements the order guide change such that the organization uses the order guide to order 45 cases of Product B per week from the Chicago distribution center instead of 45 cases of Product A per week from the Chicago distribution center. Each order guide change may be to a “local” order guide specifically used by the facility or facilities served by the distribution center providing Product B once the adjusted inventory levels are met for Product B.

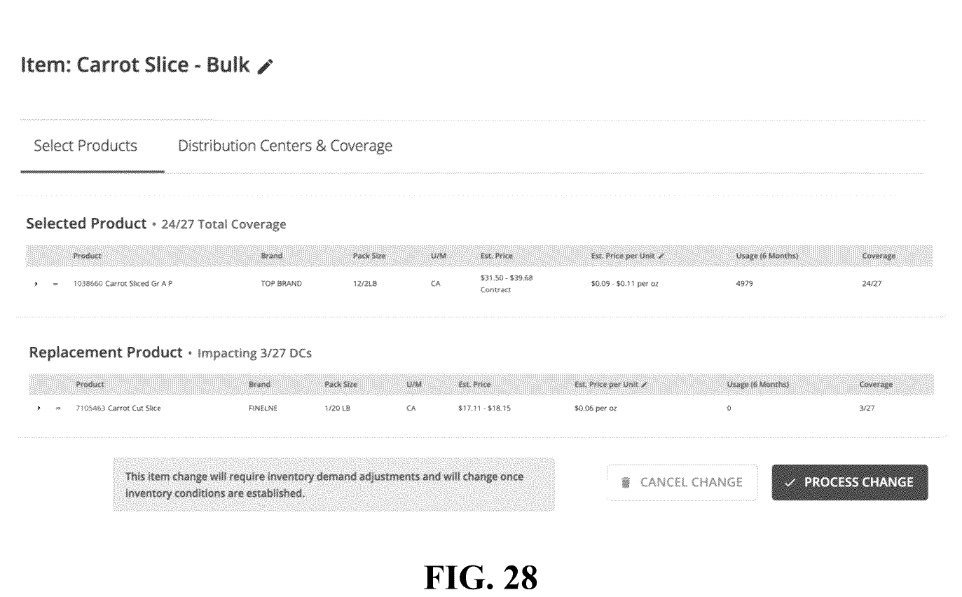

FIG. 28 shows an example order guide management user interface that can be used to request a change to an order guide, in accordance with some embodiments of the disclosed subject matter. Specifically, in FIG. 28, the user is using the order guide management user interface to replace a first product (e.g., a first type of carrots) that is on an order guide with a second product (e.g., a second type of carrots) that is not on the order guide. The user can choose to replace the first product with the second product on the order guide for various reasons as detailed herein. In the example shown in FIG. 28, the second product has a lower cost per unit than the first product. The order guide management user interface can present a variety of data associated with both the first product and the second product, as shown. For example, the order guide management user interface can present relevant information such as the current purchasing levels of the products, comparison details between the products (e.g., price, etc.), and availability information associated with the products across a set of regions (e.g., all regions associated with an organization, a subset of regions associated with an organization, etc.). Further, the order guide management user interface can include selectable user interface elements that can be selectable by the user to either process or cancel the requested change to the order guide, as shown. Moreover, the order guide management user interface can present a message (e.g., a notification) indicating that the requested change to the order guide will require inventory demand adjustments, and that the requested change to the order guide will not occur until the appropriate inventory conditions are established.

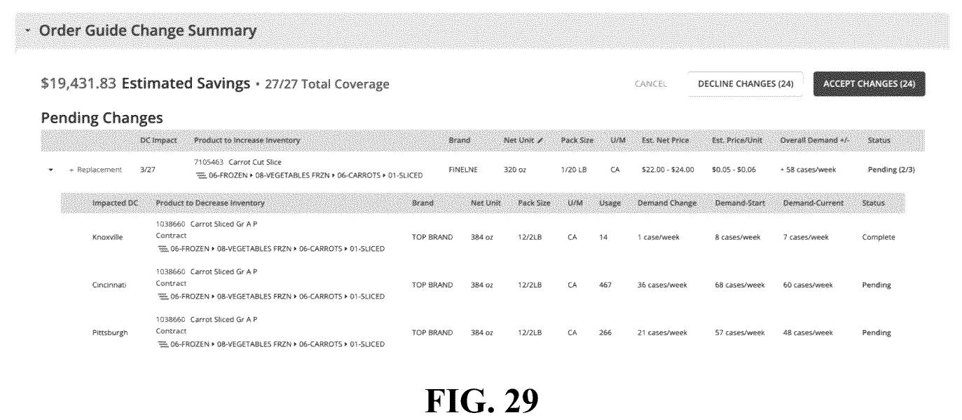

FIG. 29 shows another example order guide management user interface that can be used to manage order guide changes, in accordance with some embodiments of the disclosed subject matter. Specifically, in FIG. 29, the user is viewing an order guide change summary that provides an overview of order guide changes that are in progress (e.g., for an organization). The order guide change summary shows the user the status of both the order guide changes that are in progress and inventory changes that are being implemented in accordance with the order guide changes. The specific information shown in FIG. 29 is associated with the order guide change as shown in FIG. 28 (e.g., replacing the first type of carrots with the second type of carrots on the order guide). As shown in FIG. 29, at the time the user is accessing the order guide management user interface, the associated inventory change for a distribution center located in Knoxville has been completed, but the associated inventory change for distribution centers located in Cincinnati and Pittsburgh are still pending and have not yet been completed. Once the associated inventory change for the distribution centers located in Cincinnati and Pittsburgh are completed, the order guide change can be implemented. The order guide management user interface as shown in FIG. 29 also presents a variety of additional data to the user, such as an estimated savings (dollar amount) projected to result from implementing the requested order guide change.

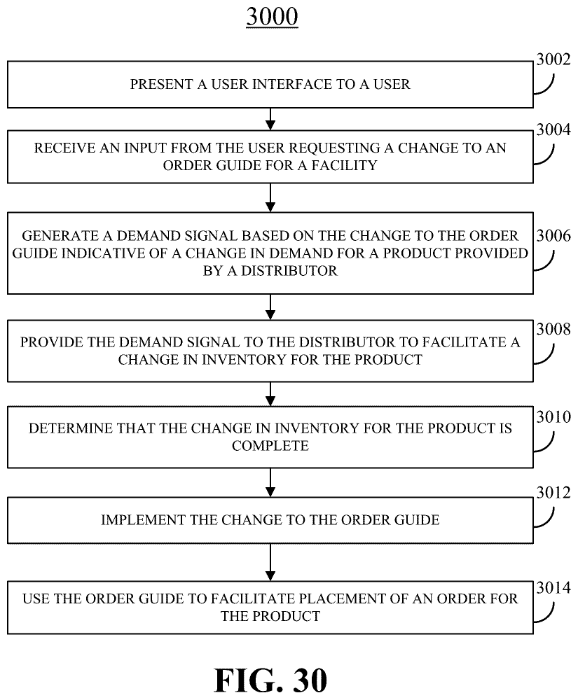

FIG. 30 shows a flowchart of an example process 3000 for coordinating product inventory with order guide changes, in accordance with some embodiments of the disclosed subject matter. Process 3000 can be performed by order management system 302, for example, to provide more dynamic collaboration between different organizations and distributors for demand changes resulting from order guide changes. Process 3000 can be used to improve the fulfillment rates of supplier distributors and for customers by systematically coordinating demand. Process 3000 can also be used to eliminate manual labor that is performed in some previous and existing approaches to coordinate inventory with changes in customer demand. This manual labor can require significant staffing costs for both the customer and the supplier whereas process 3000 can be automated and require far less cost. Moreover, the use of manual labor often relies on approximate and inaccurate information regarding customer purchasing volumes, whereas process 3000 can be far more accurate with customer purchasing information by accessing the purchasing system. Further, process 3000 can be used to reduce product loss due to excess inventory that results in demand changes from customers.

Since the order guide for an organization is often the guiding force for purchasing demand in procurement system 202, the makeup of the order guide and the inclusion (and exclusion) of products in the order guide drives demand for the supply chain and most immediately the distribution supplier that delivers products to the customer. Whenever the order guide changes, the demand for products immediately changes. However, current inventory levels do not immediately reflect the modified purchasing demand and immediate inventory levels likely are not sufficient to properly serve the modified purchasing demand.

When order guide changes are made, process 3000 can be used to accomplish automated coordination between order management system 302 and the suppliers/distributors delivering goods to the customer. For high demand items, order guide changes can be held in process (staged) until the inventor coordination occurs. While the order guide change is held in process, order management system 302 can send demand signals to the appropriate distributor logistics systems indicating the change in demand. Then, the distributor can adjust inventory levels and, when the inventory conditions reflect the demand changes, order management system 302 can complete the order guide change for the customer. It should be noted that process 3000 can also be adapted appropriately to coordinate inventory in cases of stockout swaps and other types of product substitutions within procurement system 202, as discussed above. For example, in the case of stockout swaps, a user may select Product B as a substitute for Product A (e.g., based on limited stock or stockout conditions for Product A). In such a case, a demand signal can be sent to the distributor logistics system for the originally selected product, Product A, and not the substitute product, Product B.

At 3002, process 3000 can present a user interface to a user via a user device. For example, the user interface can be a user interface that is generated by procurement system 202 and/or order management system 302 that can be used by the user to manage one or more order guides. In some examples, process 3000 can include receiving a set of login information associated with the user via an application program interface (API). Then, process 3000 can generate a request for authentication data associated with the user based on the set of login information, where the authentication data includes credentials stored in a unified database. Upon authentication of the user, process 3000 can present the user interface to the user (e.g., via a web browser, via a mobile or desktop application, etc.). The user can be associated with a facility and/or an organization, such as a facility manager or other type of individual that may be responsible for ordering products for a facility or managing the one or more order guides. The user can be part of an organization that is associated with different portions of a distribution network corresponding to different geographic areas (regions) as detailed above. There could also be separate users associated with the organization, such as one in charge of ordering products for a facility and another for managing the one or more order guides.

At 3004, process 3000 can receive an input from the user requesting a change to an order guide for an organization. For example, the user can interact with one or more selectable user interface elements (e.g., icons labeled “save”, “add”, “add to order guide”, “authorize”, “+”, etc.) and/or can provide inputs such as text inputs (e.g., via a keyboard) and/or audio inputs to initiate an order guide change via the user interface. The order guide change can be any of a variety of types of order guide changes, such as replacing Product A (e.g., a first type of chicken food product) with Product B (e.g., a second type of chicken food product) as detailed above with respect to FIG. 26. In this example, the order guide change can indicate that the facility wishes to purchase 100 cases per week of the second type of chicken food product per week instead of 100 cases of the first type of chicken food product per week going forward (e.g., due to preference of residents, due to lower cost, etc.). The number of cases can be determined from a demand signal for the original Product A (e.g., historic reoccurring order quantity for the original Product A).

At 3006, process 3000 can generate a demand signal based on the change to the order guide, where the demand signal is indicative of a change in demand for a product provided by a distributor. The demand signal can be any kind of signal that can be provided to a distributor to indicate the change in demand to the distributor for the product provided by the distributor. Also, more than one demand signal can be provided to the distributor at 3006, such that any combination of signals can be used to indicate changes in demand to the distributor in response to receiving an order guide change from the user. Continuing with the example of replacing the first type of chicken food product with the second type of chicken food product, a first demand signal can be sent to the distributor to indicate that the distributor should increase the inventory of the second type of chicken food product by 100 cases per week, and a second demand signal can be sent to the distributor to indicate that the distributor should decrease the inventory of the first type of chicken food product by 100 cases per week to accommodate the change in customer demand reflected by the order guide change.

At 3008, process 3000 can provide the demand signal to the distributor to facilitate a change in inventory for the product. The demand signal can be provided to the distributor to facilitate the change in inventory for the product in a variety of manners. For example, server 402 or computing device 430 can send the demand signal to distributor database server 410 via communication network 420. In some cases, distributor database server 410 can be accessed through one or more secure application programming interfaces. Moreover, in some examples, providing the demand signal to the distributor to facilitate the change in inventory for the product at 3008 can include automatically placing one or more purchase orders for the product on behalf of the distributor with the distributor's supply chain (e.g., one or more manufacturers or suppliers of the product). Also, the distributor can use the demand signal itself to facilitate the change in inventory for the product, for example by placing one or more inventory purchase orders or modifying an existing purchase order. The purchase orders can require varying levels of manual input depending on various parameters associated with the purchase orders, such as total cost and other parameters. The demand signal based on a future change to the order guide can be combined or aggregated with other demand signals and forecasting signals. This can be done within the distributor system, or even before the signal is provided to the distributor.

At 3010, process 3000 can determine that the change in inventory for the product has been completed. For example, process 3000 can determine that the distributor has built up a sufficient level of inventory for the product to meet the change in demand for the product provided by the distributor indicated by the received change to the order guide for the facility. Process 3000 can make this determination at 3010 in a variety of manners. For example, process 3000 can determine that the change in inventory for the product is complete responsive to determining that an inventory level for the product exceeds a threshold inventory level. The threshold inventory level can also be determined in a variety of ways, such as by using one or more models (e.g., machine learning models, artificial intelligence models) and/or by using rules. Process 3000 can also determine that the change in inventory for the product has been completed by receiving an affirmative signal from the distributor indicating that the inventory level is now appropriate. The affirmative signal can be generated based on one or more models (e.g., machine learning and artificial intelligence models), rules within the distributor system, and/or user inputs from the distributor.

Moreover, process 3000 can determine that the change in inventory for the product is complete at 3010 by accessing a database associated with the distributor (e.g., by querying distributor database server 410). In some examples, process 3000 can access the database associated with the distributor via an application programming interface (API) provided by the distributor, such as an Available Stock on Hand (ASOH) API or another similar type of API. Process 3000 can access various information through the database associated with the distributor, such as current inventory levels for different products and historical purchase order information associated with different products (e.g., purchase orders for the product with manufacturers in the distributor's supply chain). Continuing with the example of replacing the first type of chicken food product with the second type of chicken food product, for the Boston region distribution center, process 3000 can determine that the change in inventory for the second type of chicken food product is complete responsive to determining that the Boston region distribution center has increased its inventory of the second type of chicken food product by 30 cases.

At 3012, process 3000 can implement the requested change to the order guide responsive to determining that the change in inventory for the product is complete. Notably, before determining that the change in inventory for the product is complete, the order guide remains unchanged to allow the distributor sufficient time to adjust its inventory levels for the product. The order guide change can be made to a global order guide (e.g., an order guide that spans multiple facilities across different regions) and/or to a more local order guide (e.g., an order guide for an individual facility or a group of facilities in the same region). For example, each local order guide can be changed once adjustment of inventory levels for the product is complete at each corresponding regional distribution center that serves the facility or facilities using the local order guide. As another example, the change can be made to a global order guide only once adjustment of inventory levels for the product is complete at all regional distribution centers that serve the facility or facilities. Then, at 3014, process 3000 can use the order guide to place an order for the product. For example, process 3000 can use the changed order guide to place an order with the distributor by submitting the order to procurement system 202. Then, procurement system 202 can use the changed order guide to populate a procurement user interface that facilitates generation of an order by a user associated with the facility or facilities such that the order includes items from the order guide, and the user can then place the order via the procurement user interface. Since process 3000 stages the order guide change, the order can be effectively fulfilled by the distributor.

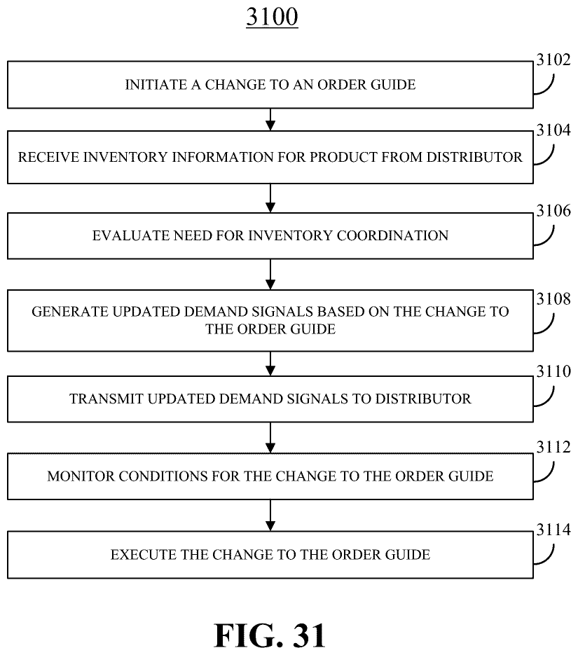

FIG. 31 shows a flowchart of another example process 3100 for coordinating product inventory with order guide changes, in accordance with some embodiments of the disclosed subject matter. Process 3100 can again be performed by order management system 302, for example, to provide more dynamic collaboration between different organizations and distributors for demand changes resulting from order guide changes. Like process 3000, process 3100 can be used to improve the fulfillment rates of supplier distributors and for customers by systematically coordinating demand. Process 3100 overlaps with process 3000, and the description of various aspects of process 3000 similarly applies to process 3100, and vice versa. However, process 3100 demonstrates a different perspective of the inventory coordination functionality disclosed herein that helps illustrate various aspects of the inventory coordination functionality.

At 3102, process 3100 can initiate a change to an order guide. The order guide change can be initiated based on various conditions. For example, the order guide change can be initiated based on a manual input from a user to change the order guide. The order guide change can also be initiated based on an automated supplier signal (input) indicating that a given product on an order guide is “leaving soon” (e.g., about to be out of stock) or is planned to be discontinued. In such examples, process 3100 can include automatically identifying the best replacement product (e.g., based on preferences, etc.) and initiate the order guide change accordingly (e.g., responsive to requesting and receiving approval from a user to do so). Further, the order guide change can be initiated automatically based on calculations of savings due to changes in pricing of one or more products. The changes in pricing can be caused, for example, by new GPO contract pricing going into effect, by normal dynamic market pricing changes, or by a change of membership from a first GPO to a second GPO.

Further, the order guide change can be initiated due to upcoming planned changes. For example, the order guide change can be initiated based on an upcoming menu system change (e.g., change in recipe, change in ingredients, etc.) or an EMR system change (e.g., change in patient needs for healthcare). Additionally, the order guide change can be initiated based on input from personnel such as procurement consultants. For example, a procurement consultant can initiate a master item change that propagates changes on one or more order guides associated with one or more customers and their facilities. In such an example, the master item change can essentially represent a bulk simultaneous order guide change that adds and/or removes products from multiple order guides associated with multiple customers, and thus can affect many facilities at once. This type of change may result in a large aggregate demand change for distributors that may otherwise be difficult to detect if the change appeared as a small change in demand from each of the affected customers. Upon initiating the order guide change, process 3100 can place the order guide change in a pending (staged) status.

At 3104, process 3100 can receive inventory information for a product associated with the change to the order guide from a distributor associated with the product. Process 3100 can include calculating inventory information for the product associated with the change to the order guide based on current inventory levels and projected inventory levels. For example, process 3100 can include projecting inventory levels for the product associated with the change to the order guide based on upcoming purchase orders (POs) from suppliers. Process 3100 can also include retrieving current inventory levels associated with the product associated with the change to the order guide based by distribution center.

At 3106, process 3100 can evaluate the need for inventory coordination to be performed based at least in part on the inventory information received at 3104. Inventory coordination may not be necessary if the demand change is considered immaterial to the normal demand fluctuation and inventory management capabilities. In some examples, suppliers can establish one or more rules pertaining to minimum thresholds of how much change in demand should result in delaying a requested order guide change. The threshold can be a threshold percentage of a current demand level (e.g., if current demand level changes by more than X %, then delay change in order guide) or a specific minimum threshold number of units, for example. If the order guide change is based on an automated process, then the order guide change can be delayed for the purpose of evaluating an aggregated change in demand across multiple customers with varying review processes and/or workflows.

Process 3100 can include comparing an aggregate demand signal to various thresholds (sensitivity levels) associated with different entities to determine whether staging is necessary. For example, if the aggregate demand signal indicates that the change in demand is below a threshold, process 3100 can include determining that the change in demand is too small to warrant staging because the distributor can absorb the change without staging. In such a scenario, process 3100 can proceed to 3114 and automatically execute the change to the order guide (without performing 3108, 3110, or 3112). However, if the aggregate demand signal indicates that the change in demand is above a threshold, process 3100 can include determining that an updated demand signal should be provided to one or more distributors initiate one or more changes in inventory level. The evaluation performed at 3106 can including comparing the aggregated demand signal to the availability information associated with multiple distribution centers. For example, if Customer A only needs 2 cases per week of a product associated with the order guide change, process 3100 can determine that staging is not necessary, and can proceed to 3114. However, if customers A through Z each need 2 cases per week of the product associated with the order guide change across multiple distribution centers, then process 3100 can determine that staging is required to stock up inventory before executing the order guide change. In some examples, if the order guide change is based on a change that affects multiple order guides and/or customers simultaneously, then process 3100 can automatically determine that inventory coordination (e.g., staging) is required (e.g., without comparing to any thresholds).

At 3108, process 3100 can generate one or more updated demand signals (if necessary) based on the change to the order guide. For example, process 3100 can calculate updated aggregate demand signals across multiple customers, facilities, and distribution centers. The calculation can be based on a variety of factors. For example, the calculation can be based on purchase history, customer operating information (e.g., healthcare facility census, expected level of occupancy for a hotel, etc.), customer purchasing patterns, menu system integration (e.g., to determine how much product is projected to be in demand based on planned menus, can account for seasonal changes), and/or EMR integration (e.g., to determine how much product is projected to be required based on clinical assessments of patients and overall changes in patient needs). The calculation can account for the compliance level of each facility order guide for the product (e.g., supposed to order X amount, but only have 70% compliance). Even if the customer's desire is not to transfer 100% of demand from one product to the another, the demand level can be altered by an existing pattern (metric) of how well field purchasers follow corporate guidelines, for example. The demand signals can be generated by distribution center.

At 3110, process 3100 can transmit one or more updated demand signals (if necessary) to the distributor associated with the product. The updated demand signals can be transmitted in various suitable manners and can be broken out by regional distribution center. For example, a real-time system API can be used to transmit updated demand signals to a distribution logistics system or to generate a task for a distributor to review and/or update inventory. Process 3100 can generate a report of information associated with updated demand signals to send via email, or to send via another type of data file (e.g., document, spreadsheet, etc.).

At 3112, process 3100 can monitor one or more conditions associated with the change to the order guide (if necessary). The monitoring can be performed using automated monitoring methods. For example, process 3100 can monitor distributor inventor levels of the product relative to one or more criteria (e.g., new product has increased inventory, old product has decreased inventory). Process 3100 can also monitor purchase activity (e.g., the customer has purchased X amount of old product fulfilling any obligation of purchasing existing inventory) that can be used in combination with inventory level criteria, for example. Process 3100 can use a time delay to implement a rule to move forward and execute an order guide change after a maximum amount of time has passed. Process 3100 can also monitor a product availability signal to determine that, if larger changes occur to the distributor's status of offering an item, that can cause the order guide change to execute. For example, if a change involves switching from Product A to Product B, and Product A becomes discontinued and no longer offered by the distributor, then the change can move forward and execute to Product B. Further, process 3100 can use a manual approval (e.g., from a distributor, from a procurement consultant, etc.) to determine that the change to the order guide should be executed. Process 3100 can also use a task systems signal such as a systematic communication (e.g., received via an API) that is set up between a workflow system associated with the distributor and the order guide system (e.g., order management system 302) to mark the completion of a task as a signal to move forward with the execution of the change to the order guide, among other types of signals that can be used to monitor one or more conditions associated with the change to the order guide.

At 3114, process 3100 can execute the change to the order guide. Process 3100 can implement both full and partial changes to the order guide. For example, based on one or more rules, process 3100 can determine that, if the change to the order guide involves multiple products or multiple regional distribution centers, then a portion of the order guide change can execute if conditions are met for that portion. Also, the change to the order guide can be configured only to execute after all conditions are met for all products and regions associated with the change to the order guide. The change to the order guide can be executed automatically based on determining that distributor inventory level (or projected inventory level) meets a threshold level of demand. In some examples, process 3100 can implemented a paired product order guide change by adding a “new” product to the order guide and removing an “old” product from the order guide before executing the change to the order guide. This type of change can require that both the new and old products are at appropriate levels. The products can also be handled separately, which can result in some overlap where both the new and old products can be ordered for a period of time. Process 3100 can require one or more manual approvals (e.g., from suppliers, distributors, procurement consultants, etc.) to execute the change to the order guide in some examples. Process 3100 can also execute the change to the order guide based on other factors such as a time period that has elapsed since the change to the order guide was staged or initiated, product availability from suppliers (e.g., new product is now available, product has been discontinued, etc.), and/or other conditions.

It should be noted that, as used herein, the term mechanism can encompass hardware, software, firmware, or any suitable combination thereof. It should be understood that the steps of the processes described above can be executed or performed in any order or sequence not limited to the order and sequence shown and described in the figures. Also, some of the above steps of the processes can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A computer-implemented method for coordinating inventory changes, comprising:
initiating a change to an order guide that is used to order products for a facility;
generating a demand signal based on the change to the order guide, the demand signal indicative of a change in demand for a product that is provided by a distributor;
providing the demand signal to the distributor such that the demand signal can be used to facilitate a change in inventory for the product that is provided by the distributor;
determining that the change in inventory for the product that is provided by the distributor is complete;
implementing the change to the order guide that is used to order products for the facility responsive to determining that the change in inventory for the product that is provided by the distributor is complete; and
using the order guide to facilitate placement of an order for the product that is provided by the distributor for the facility after implementing the change to the order guide.

2. The method of claim 1, wherein initiating the change to the order guide comprises receiving a request to replace a first product that is on the order guide with a second product that is not on the order guide.

3. The method of claim 1, wherein:
determining that the change in inventory for the product that is provided by the distributor is complete comprises determining that an inventory level for the product that is provided by the distributor exceeds a threshold inventory level; and
the method comprises determining the threshold inventory level by evaluating the change to the order guide relative to one or more rules.

4. The method of claim 1, wherein:
determining that the change in inventory for the product that is provided by the distributor is complete comprises determining that an inventory level for the product that is provided by the distributor exceeds a threshold inventory level; and
the method comprises determining the threshold inventory level by applying the change to the order guide to one or more models.

5. The method of claim 1, wherein providing the demand signal to the distributor comprises providing the demand signal to the distributor responsive to determining that the change in demand for the product is above a threshold.

6. The method of claim 1, comprising causing a user interface to present an indication that the change to the order guide is pending responsive to determining that the change in demand for the product is above a threshold.

7. The method of claim 1, wherein determining that the change in inventory for the product that is provided by the distributor is complete comprises accessing purchase order information for the product via a database associated with the distributor through an application programming interface.

8. The method of claim 1, wherein:
initiating the change to the order guide comprises initiating a change to a general order guide that is used to facilitate creation of a first facility order guide that is used to order products for a first facility and a second facility order guide that is used to order products for a second facility:
generating the demand signal comprises generating a first demand signal and a second demand signal based on the change to the general order guide, the first demand signal indicative of a first change in demand for a first product that is provided by a first distribution center that serves the first facility, and the second demand signal indicative of a second change in demand for a second product that is provided by a second distribution center that serves the second facility;
providing the demand signal to the distributor comprises providing the first demand signal to the first distribution center such that the first demand signal can be used to facilitate a first change in inventory for the first product that is provided by the first distribution center and providing the second demand signal to the second distribution center such that the second demand signal can be used to facilitate a second change in inventory for the second product that is provided by the second distribution center;
determining that the change in inventory is complete comprises determining that the first change in inventory and the second change in inventory are complete;
implementing the change to the order guide comprises implementing a first change to the first facility order guide based on the change to the general order guide responsive to determining that the first change in inventory is complete and implementing a second change to the second facility order guide based on the change to the general order guide responsive to determining that the second change in inventory is complete; and
using the order guide to facilitate placement of the order comprises using the first facility order guide to facilitate placement of a first order for the first product that is provided by the first distribution center for the first facility and using the second facility order guide to facilitate placement of a second order for the second product that is provided by the second distribution center for the second facility.

9. The method of claim 1, comprising:
initiating a second change to the order guide that is used to order products for the facility;
generating a second demand signal based on the second change to the order guide, the demand signal indicative of a second change in demand for a second product that is provided by the distributor;
determining that the second change in demand is below a threshold; and
implementing the second change to the order guide responsive to determining that the second change in demand is below the threshold.

10. The method of claim 1, comprising maintaining the order guide without implementing the change to the order guide until determining that the change in inventory for the product that is provided by the distributor is complete.

11. The method of claim 1, wherein providing the demand signal to the distributor such that the demand signal can be used to facilitate the change in inventory for the product that is provided by the distributor comprises automatically placing a purchase order for the product on behalf of the distributor.

12. The method of claim 1, wherein initiating the change to the order guide comprises initiating the change to the order guide responsive to receiving a user input requesting the change to the order guide from a user device, the method comprising:
receiving a set of login information associated with the user via an application program interface;
responsive to receiving the set of login information, generating a request for authentication data associated with the user, wherein the authentication data includes credentials stored in a unified database; and
upon authentication, causing a user interface to be presented to the user via the user device;
wherein receiving the user input from the user submitted via the user device comprises receiving the user input from the user via the user interface.

13. The method of claim 1, wherein using the order guide to facilitate placement of the order for the product comprises providing the order guide to a procurement system, the procurement system configured to:
use the order guide to populate a procurement system user interface that facilitates generation of the order such that the order includes the product that is provided by the distributor; and
place the order with the distributor based on a user input that is received via the procurement system user interface.

14. The method of claim 1, comprising implementing the change to the order guide that is used to order products for the facility responsive to receiving an approval of the change to the order guide.

15. The method of claim 1, wherein initiating the change to the order guide that is used to order products for the facility comprises initiating the change to the order guide that is used to order products for the facility responsive to receiving a user input requesting the change to the order guide that is used to order products for the facility from a user device.

16. The method of claim 2, wherein initiating the change to the order guide that is used to order products for the facility comprises automatically initiating the change to the order guide that is used to order products for the facility responsive to determining that a supplier associated with the first product has stopped supplying the first product.

17. The method of claim 2, wherein initiating the change to the order guide that is used to order products for the facility comprises automatically initiating the change to the order guide that is used to order products for the facility based on a price change associated with the first product.

18. The method of claim 1, wherein initiating the change to the order guide that is used to order products for the facility comprises automatically initiating the change to the order guide based on a group purchasing organization (GPO) contract.

19. A non-transitory computer-readable storage medium having instructions stored thereon that, when executed by processing circuitry, cause the processing circuitry to:
initiate a change to an order guide that is used to order products for a facility;
generate a demand signal based on the change to the order guide, the demand signal indicative of a change in demand for a product that is provided by a distributor;
provide the demand signal to the distributor such that the demand signal can be used to facilitate a change in inventory for the product that is provided by the distributor;
determine that the change in inventory for the product that is provided by the distributor is complete;
implement the change to the order guide that is used to order products for the facility responsive to determining that the change in inventory for the product that is provided by the distributor is complete; and
use the order guide to facilitate placement of an order for the product that is provided by the distributor for the facility after implementing the change to the order guide.

20. A system for coordinating inventory changes, comprising:
memory comprising machine-readable instructions; and
processing circuitry configured to execute the machine-readable instructions to:
initiate a user input from a user submitted via a user device, the user input requesting a change to an order guide that is used to order products for a facility;
generate a demand signal based on the change to the order guide, the demand signal indicative of a change in demand for a product that is provided by a distributor;
provide the demand signal to the distributor such that the demand signal can be used to facilitate a change in inventory for the product that is provided by the distributor;
determine that the change in inventory for the product that is provided by the distributor is complete;
implement the change to the order guide that is used to order products for the facility responsive to determining that the change in inventory for the product that is provided by the distributor is complete; and
use the order guide to facilitate placement of an order for the product that is provided by the distributor for the facility after implementing the change to the order guide.

21. The method of claim 8, wherein the first product and the second product are different products.

22. The method of claim 1, comprising:
initiating a second change to the order guide in conjunction with the change to the order guide;
generating a second demand signal based on the second change to the order guide, the second demand signal indicative of a second change in demand for a second product that is provided by the distributor;
providing the second demand signal to the distributor such that the second demand signal can be used to facilitate a second change in inventory for the second product that is provided by the distributor; and
implementing the second change to the order guide responsive to implementing the first change to the order guide or responsive to determining that the second change in inventory for the second product that is provided by the distributor is complete.

23. The method of claim 22, wherein:
the change in demand for the product that is provided by the distributor comprises an increase in demand for the product that is provided by the distributor; and
the second change in demand for the second product that is provided by the distributor comprises a decrease in demand for the second product that is provided by the distributor.
